(19) United States
(12) Patent Application Publication
(10) Pub. No.: US 2022/0327430 A1
(43) Pub. Date: Oct. 13, 2022

(54) PREDICTING TARGETED REDEMPTION EVENTS USING TRAINED ARTIFICIAL-INTELLIGENCE PROCESSES

(71) Applicant: The Toronto-Dominion Bank, Toronto (CA)

(72) Inventors: Saba Zuberi, Toronto (CA); Maksims Volkovs, Toronto (CA); Tomi Poutanen, Toronto (CA)

(21) Appl. No.: 17/712,132

(22) Filed: Apr. 2, 2022

Related U.S. Application Data
(60) Provisional application No. 63/172,546, filed on Apr. 8, 2021.

(51) Int. Cl. G06N 20/20; G06Q 40/06

(52) U.S. Cl. CPC G06N 20/20; G06Q 40/06

(57) ABSTRACT

The disclosed embodiments include computer-implemented systems and methods that facilitate a prediction of future occurrences of redemption events using adaptively trained artificial intelligence processes. For example, an apparatus may generate an input dataset based on elements of first interaction data associated with a first temporal interval. Based on an application of a trained artificial intelligence process to the input dataset, the apparatus may generate output data representative of a predicted likelihood of an occurrence of each of a plurality of targeted events during a second temporal interval. The apparatus may also transmit at least a portion of the output data and explainability data associated with the trained artificial intelligence process to a computing system, which may perform operations based on the portion of the output data and the explainability data.

### CROSS-REFERENCE TO RELATED APPLICATION

This application claims the benefit of priority under 35 U.S.C. § 119(e) to prior U.S. Provisional Application No. 63/172,546, filed Apr. 8, 2021, the disclosure of which is incorporated by reference herein to its entirety.

### TECHNICAL FIELD

The disclosed embodiments generally relate to computer-implemented systems and processes that facilitate a prediction of future occurrences of redemption events using adaptively trained artificial intelligence processes.

### BACKGROUND

Today, many financial institutions offer a variety of financial products or services to their customers, both through in-person branch banking and through various digital channels. The financial products and services may include one or more mutual funds managed by the financial institution, and the customers of the financial institution may purchase shares of these mutual funds and may hold these mutual funds over corresponding temporal intervals.

### SUMMARY

In some examples, an apparatus includes a memory storing instructions, a communications interface, and at least one processor coupled to the memory and the communications interface. The at least one processor is configured to execute the instructions to generate an input dataset based on elements of first interaction data associated with a first temporal interval. The at least one processor is further configured to execute the instructions to, based on an application of a trained artificial intelligence process to the input dataset, generate output data representative of a predicted likelihood of an occurrence of each of a plurality of targeted events during a second temporal interval. The second temporal interval is subsequent to the first temporal interval and is separated from the first temporal interval by a corresponding buffer interval. The at least one processor is configured to execute the instructions to transmit at least a portion of the output data and explainability data associated with the trained artificial intelligence process to a computing system via the communications interface. The computing system is configured to perform operations based on the portion of the output data and the explainability data.

In other examples, a computer-implemented method includes generating, using at least one processor, an input dataset based on elements of first interaction data associated with a first temporal interval. The computer-implemented method includes, based on an application of a trained artificial intelligence process to the input dataset, generating, using the at least one processor, output data representative of a predicted likelihood of an occurrence of each of a plurality of targeted events during a second temporal interval. The second temporal interval is subsequent to the first temporal interval and is separated from the first temporal interval by a corresponding buffer interval. The computer-implemented method includes transmitting, using the at least one processor, at least a portion of the output data and elements of explainability data associated with the trained artificial intelligence process to a computing system. The computing system is configured to perform operations based on the portion of the output data and the explainability data.

Further, in some examples, a tangible, non-transitory computer-readable medium stores instructions that, when executed by at least one processor, cause the at least one processor to perform a method that includes generating an input dataset based on elements of first interaction data associated with a first temporal interval. The method also includes, based on an application of a trained artificial intelligence process to the input dataset, generating output data representative of a predicted likelihood of an occurrence of each of a plurality of targeted events during a second temporal interval. The second temporal interval is subsequent to the first temporal interval and is separated from the first temporal interval by a corresponding buffer interval. The method also includes transmitting at least a portion of the output data and elements of explainability data associated with the trained artificial intelligence process to a computing system. The computing system is configured to perform operations based on the portion of the output data and the explainability data.

It is to be understood that both the foregoing general description and the following detailed description are exemplary and explanatory only and are not restrictive of the invention, as claimed. Further, the accompanying drawings, which are incorporated in and constitute a part of this specification, illustrate aspects of the present disclosure and together with the description, serve to explain principles of the disclosed exemplary embodiments, as set forth in the accompanying claims.

### BRIEF DESCRIPTION OF THE DRAWINGS

FIGS. 1A and 1B are block diagrams illustrating portions of an exemplary computing environment, in accordance with some exemplary embodiments.

FIGS. 1C and 1D are diagrams of exemplary timelines for adaptively training a machine-learning or artificial intelligence process, in accordance with some exemplary embodiments.

FIG. 2 is a block diagram illustrating additional portions of the exemplary computing environment, in accordance with some exemplary embodiments.

FIG. 3 is a flowchart of an exemplary process for adaptively training a machine learning or artificial intelligence process, in accordance with some exemplary embodiments.

FIG. 4 is a flowchart of an exemplary process for predicting a likelihood of future occurrences of events based on an application of an adaptively trained machine-learning or artificial-intelligence process to customer-specific input datasets, in accordance with some exemplary embodiments.

FIG. 5 is a flowchart of an exemplary process for generating a redemption persona for each customer and engaging the customers based on the generated redemption personas to prevent future redemption events, in accordance with some exemplary embodiments.

Like reference numbers and designations in the various drawings indicate like elements.

### DETAILED DESCRIPTION

Modern financial institutions offer a variety of financial products or services to their customers, both through in-person branch banking and through various digital channels. The financial products and services may include, among other things, one or more mutual fund products, and in some instances, a customer of the financial institution may purchase one or more units, or shares, of these mutual fund products from the financial institution (e.g., priced in accordance with a new-asset value (NAV) of the underlying securities associated with the mutual fund products), and may hold the purchased shares of the mutual fund products throughout one or more temporal intervals, e.g., as a portion of a customer's investment portfolio. Further, in some instances, and subsequent to the purchase of the shares of the mutual fund products, the customer may elect to withdraw all, or a portion of, a current market value of these mutual fund products, e.g., to “redeem” all or a portion of the market value (e.g., in accordance with a next available NAV of the underlying securities).

The customer's decision to redeem all, or a selected portion of, the market value of the one or more units mutual fund products may be based on, and informed by, a variety of financial, market-based, or personal considerations. For example, the customer's decision may be driven by, among other things, changes in the market value of the mutual fund products, or by a decision to invest in other financial or investment products offered by the financial institution using proceeds from the redemption. In other examples, the customer may experience a change in a financial position, or may be dissatisfied with a performance of, or disinterested in, the one or more mutual fund products, and the customer may elect to purchase other financial or investment products offered by additional, or alternate, financial institutions using the proceeds of the redemption, or may elect to fund other purchases using the proceeds from the redemption. Further, in some examples, personal considerations may inform the customer's decision to redeem all, or a selected portion of, the market value of the one or more units mutual fund products, and examples of these personal considerations may include, among other things, a change in a marital status, a birth or adoption of a child, or a purchase of a home, e.g., funded by portion of the proceeds of the redemptions.

As described herein, a redemption of all, or a selected portion of, a market value of one or more shares of a mutual fund products held by a customer may represent an occurrence of a redemption event involving the customer, and the one or more shares of the mutual fund product, during a corresponding temporal interval. In some instances, the financial institution may not only attempt to identify one or more customers that represent “likely” candidates for involvement in future redemption events, and but also to address one or more financial or non-financial considerations that prompt these customers to initiate corresponding redemption events, e.g., to prevent the future occurrences of these redemption events and maintain the customers' positions in the mutual fund products. For example, one or more computing systems of the financial institution may perform operations that identify a particular customer of the financial institution that holds shares in a mutual fund product as a likely candidate for involvement in a future redemption event based on an application of one or more subjective or rules-based processes to elements of data characterizing the customer, the customer's interaction with the financial institution and with financial products or services provisioned by the financial institution, or a performance of the mutual funds.

Although these subjective, rules-based processes may identify customers of the financial institution that share various demographic or financial characteristics with other customers involved in prior redemption events, these subject, rules-based processes are often incapable of analyzing and identifying time-evolving trends in the customer's spending or transaction behavior, or time-evolving tends in a performance of one or more financial products (including shares in the mutual fund product) held by the customer, that would indicate a likely future occurrence of a redemption event involving portions of the shares in the mutual fund product, much of providing any insight into the underlying rationale or consideration that prompt the initiation of the redemption event. Furthermore, given the increasing volume of the data characterizing customers of the financial institution, and the interactions of the customers with the financial institution and with financial products or services provisioned by the financial institution, maintained by the one or more FI computing systems on behalf of their customers, some existing analytical processes may be incapable of analyzing the maintained elements of customer—or interaction-specific data in time frames sufficient to support a determination that a customer represents a likely candidate for involvement in a redemption event in real-time, and prior to the actual occurrence of that redemption event.

In some examples, described herein, a machine-learning or artificial-intelligence process may be adaptively trained to predict a likelihood of an occurrence of each of a plurality of targeted redemption events involving a customer and a corresponding mutual fund product during a future temporal interval using training data associated with a first prior temporal interval, and using validation data associated with a second, and distinct, prior temporal interval. The machine-learning or artificial-intelligence process may include an ensemble or decision-tree process, such as a gradient-boosted decision-tree process (e.g., XGBoost process), and the training and validation data may include, but are not limited to, elements of profile, account, transaction, portfolio, redemption, engagement, and market data characterizing corresponding ones of the customers of the financial institution associated with a position in one or more mutual funds that exceed a predetermined value (e.g., $1,500, etc.), along with elements of redemption data identifying and characterizing prior occurrences of redemption events associated with, or involving, the corresponding customers (e.g., that exclude redemptions that fund purchase of other investment products offered by the financial institution or a repurchase of additional mutual fund products offered by the financial institution).

Through the implementation of the exemplary processes described herein, the one or more FI computing systems (e.g., which may collectively establish a distributed computing cluster associated with the financial institution) may perform operations that adaptively, and successively, train and validate the machine-learning or artificial-intelligence process based on corresponding subsets of the training and validation data. Further, the trained machine-learning or artificial-intelligence process (e.g., the trained gradient-boosted, decision-tree process described herein) may further ingest input datasets associated with one or more customers of the financial institution, and based on an application of the trained machine-learning or artificial-intelligence process to the input datasets, the one or more FI computing systems may generate elements of output data indicative of a likelihood, for each of the one or more customers, of each of (i) an occurrence of a full redemption event involving shares of a mutual fund product (e.g., a redemption of greater than 95% of a current market value of the shares of the mutual fund product), (ii) an occurrence of a partial redemption event (e.g., a redemption of between 10% and 95% of the current market value), or (iii) a non-occurrence of a redemption event (e.g., a redemption of less than 10% of the current market value) during the future temporal interval.

The generated elements of output data may, in some instances, enable one or more computing systems operated by the financial instruction to perform operations that engage, proactively, one or more of the customers (e.g., those associated with predicted occurrences of full or partial redemptions) in an attempt to prevent any future redemption. Furthermore, and through the application of the trained machine-learning or artificial-intelligence process to the input datasets, the one or more computing systems of the financial institution may generate elements of explainability data that identify, and characterize, a contribution of each, or subset of, the discrete features of the input datasets to the predicted output data. The one or more computing systems of the financial institution may perform any of the exemplary processes described herein to apply an additional, or alternate, trained machine-learning or artificial-intelligence process to the features and to values characterizing corresponding ones of the contributions (e.g., a clustering algorithm, such as a k-means clustering algorithm, etc.). Based on an application of the additional, or alternate, trained machine-learning or artificial-intelligence process to the features an contribution values, the one or more computing systems of the financial institution may perform operations, described herein, that identify one or more clusters of features establishing, for customers of the financial institution, respective behavioral patterns indicative of a likely customer involvement in a future redemption event (e.g., respective redemption “personas”), which may further facilitate a proactive engagement of customers of the financial institution prior to actual occurrences of redemption events.

Certain of these exemplary processes, which adaptively train and validate a gradient-boosted, decision-tree process using customer-specific training and validation datasets associated with respective training and validation periods, and which apply the trained and validated gradient-boosted, decision-tree process to additional customer-specific input datasets, may enable the one or more of the FI computing systems to predict, in real-time, a likelihood of an occurrence of a redemption event involving one or more customers of the financial institution and corresponding mutual funds products during a predetermined, future temporal interval (e.g., via an implementation of one or more parallelized, fault-tolerant distributed computing and analytical protocols across clusters of graphical processing units (GPUs) and/or tensor processing units (TPUs)). These exemplary processes may, for example, be implemented by the one or more computing systems of the financial institution in addition to, or as alternative to, exiting subjective, rules based processes for identifying customers that represent likely candidate for involvement in future redemption events.

### A. Exemplary Processes for Adaptively Training Gradient-Boosted, Decision Tree Processes in a Distributed Computing Environment

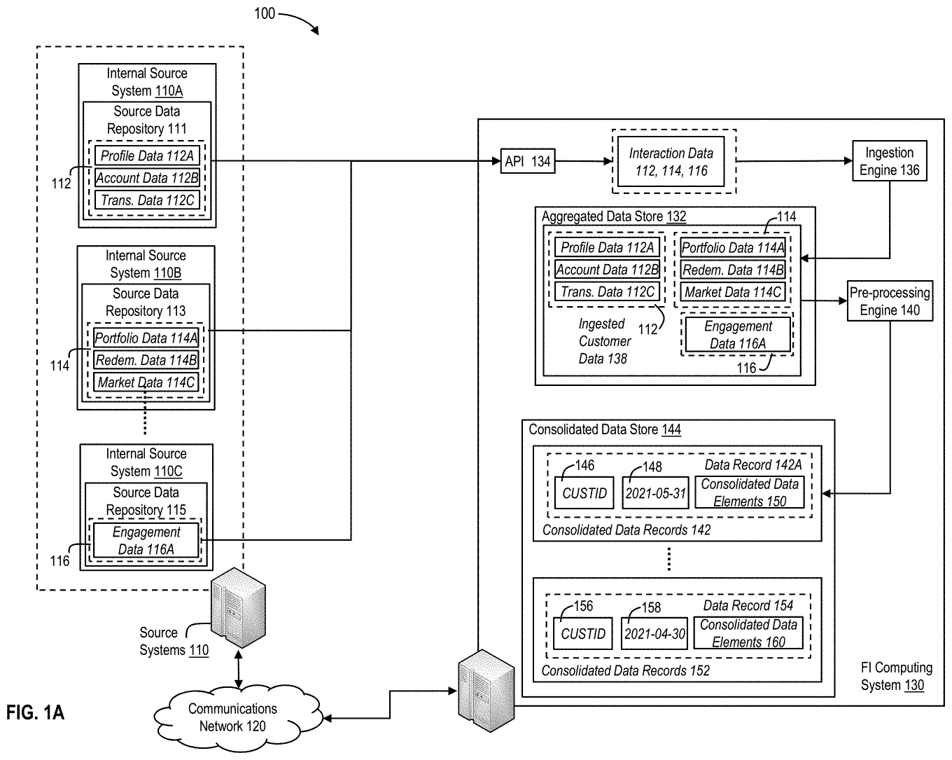

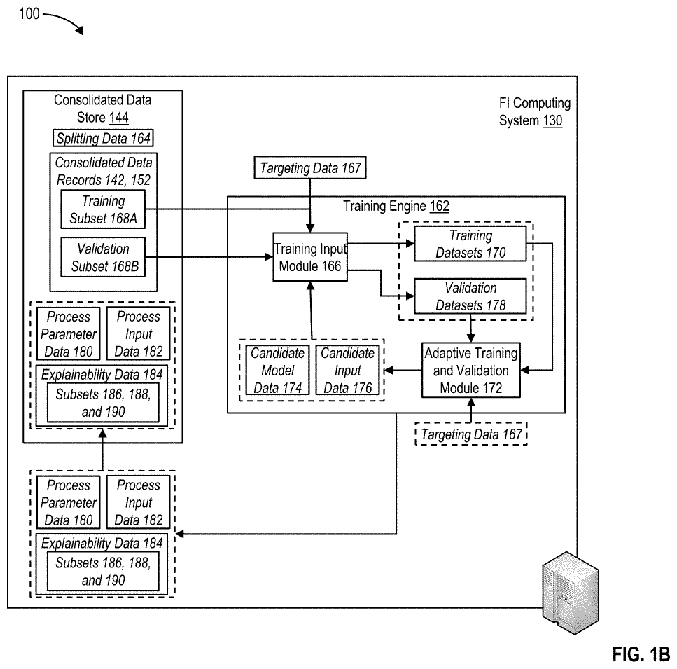

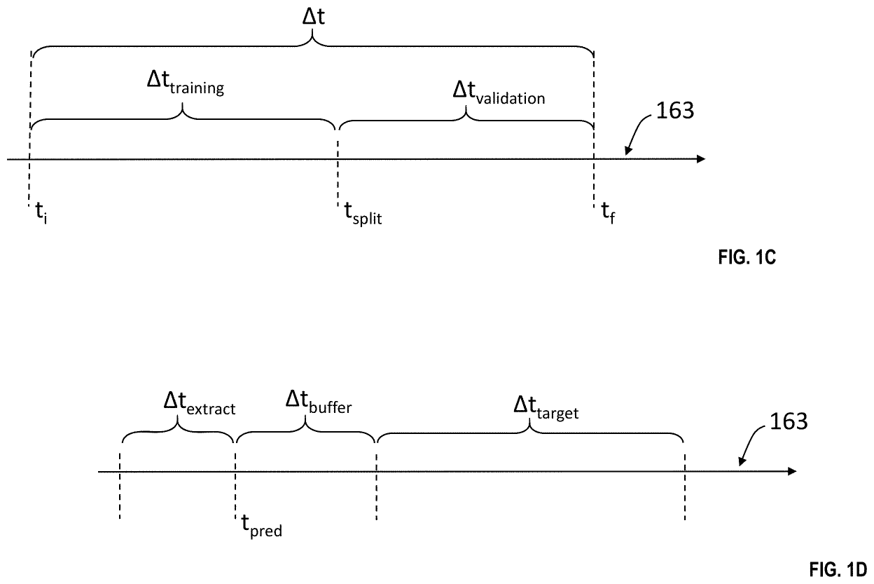

FIGS. 1A and 1B illustrate components of an exemplary computing environment 100, in accordance with some exemplary embodiments. For example, as illustrated in FIG. 1A, environment 100 may include one or more source systems 110, such as, but not limited to, source system 110A, source system 110B, and source system 110C and a computing system associated with, or operated by, a financial institution, such as financial institution (FI) computing system 130. In some instances, each of source systems 110 (including source systems 110A, 1108, and 110C), and FI computing system 130 may be interconnected through one or more communications networks, such as communications network 120. Examples of communications network 120 include, but are not limited to, a wireless local area network (LAN), e.g., a “Wi-Fi” network, a network utilizing radio-frequency (RF) communication protocols, a Near Field Communication (NFC) network, a wireless Metropolitan Area Network (MAN) connecting multiple wireless LANs, and a wide area network (WAN), e.g., the Internet.

In some examples, each of source systems 110 (including source systems 110A, 1108, and 110C) and FI computing system 130 may represent a computing system that includes one or more servers and tangible, non-transitory memories storing executable code and application modules. Further, the one or more servers may each include one or more processors, which may be configured to execute portions of the stored code or application modules to perform operations consistent with the disclosed embodiments. For example, the one or more processors may include a central processing unit (CPU) capable of processing a single operation (e.g., a scalar operations) in a single clock cycle. Further, each of source systems 110 (including source system 110A, source system 1108, and source system 110C) and FI computing system 130 may also include a communications interface, such as one or more wireless transceivers, coupled to the one or more processors for accommodating wired or wireless internet communication with other computing systems and devices operating within environment 100.

Further, in some instances, source systems 110 (including source systems 110A, 1108, and 110C) and FI computing system 130 may each be incorporated into a respective, discrete computing system. In additional, or alternate, instances, one or more of source systems 110 (including source systems 110A, 1108, and 110C) and FI computing system 130 may correspond to a distributed computing system having a plurality of interconnected, computing components distributed across an appropriate computing network, such as communications network 120 of FIG. 1A. For example, FI computing system 130 may correspond to a distributed or cloud-based computing cluster associated with, and maintained by, the financial institution, although in other examples, FI computing system 130 may correspond to a publicly accessible, distributed or cloud-based computing cluster, such as a computing cluster maintained by Microsoft Azure™ Amazon Web Services™, Google Cloud™, or another third-party provider.

In some instances, FI computing system 130 may include a plurality of interconnected, distributed computing components, such as those described herein (not illustrated in FIG. 1A), which may be configured to implement one or more parallelized, fault-tolerant distributed computing and analytical processes (e.g., an Apache Spark™ distributed, cluster-computing framework, a Databricks™ analytical platform, etc.). Further, and in addition to the CPUs described herein, the distributed computing components of FI computing system 130 may also include one or more graphics processing units (GPUs) capable of processing thousands of operations (e.g., vector operations) in a single clock cycle, and additionally, or alternatively, one or more tensor processing units (TPUs) capable of processing hundreds of thousands of operations (e.g., matrix operations) in a single clock cycle. Through an implementation of the parallelized, fault-tolerant distributed computing and analytical protocols described herein, the distributed computing components of FI computing system 130 may perform any of the exemplary processes described herein, to ingest elements of data, to preprocess the ingested data elements by filtering, aggregating, or down-sampling certain portions of the ingested data elements, and to store the preprocessed data elements within an accessible data repository (e.g., within a portion of a distributed file system, such as a Hadoop distributed file system (HDFS)).

Further, and through an implementation of the parallelized, fault-tolerant distributed computing and analytical protocols described herein, the distributed components of FI computing system 130 may perform operations in parallel that not only train adaptively a machine learning or artificial intelligence process (e.g., the gradient-boosted, decision-tree process described herein) using corresponding training and validation datasets extracted from temporally distinct subsets of the preprocessed data elements, but also apply the adaptively trained machine learning or artificial intelligence process to customer-specific input datasets and generate, in real time, elements of output data indicative of a likelihood of an occurrence of each of a plurality of targeted redemption events involving corresponding ones of the customers and corresponding mutual fund products during a future temporal interval, such a two-month interval between one and three months from a prediction date. The implementation of the parallelized, fault-tolerant distributed computing and analytical protocols described herein across the one or more GPUs or TPUs included within the distributed components of FI computing system 130 may, in some instances, accelerate the training, and the post-training deployment, of the machine-learning and artificial-intelligence process when compared to a training and deployment of the machine-learning and artificial-intelligence process across comparable clusters of CPUs capable of processing a single operation per clock cycle.

Referring back to FIG. 1A, each of source systems 110 may maintain, within corresponding tangible, non-transitory memories, a data repository that includes confidential data associated with the customers of the financial institution and financial products or services provisioned by the financial institution. For example, source system 110A may be associated with, or operated by, the financial institution, and may maintain, within the corresponding one or more tangible, non-transitory memories, a source data repository 111 that includes one or more elements of interaction data 112. In some instances, interaction data 112 may include data that identifies or characterizes one or more customers of the financial institution and interactions between these customers and the financial institution, and examples of the confidential data include, but are not limited to, profile data 112A, account data 112B, and/or transaction data 112C.

In some instances, profile data 112A may include a plurality of data records associated with, and characterizing, corresponding ones of the customers of the financial institution. By way of example, and for a particular customer of the financial institution, the data records of profile data 112A may include, but are not limited to, one or more unique customer identifiers (e.g., an alphanumeric character string, such as a login credential, a customer name, etc.), residence data (e.g., a street address, etc.), other elements of contact data (e.g., a mobile number, an email address, etc.), values of demographic parameters that characterize the particular customer (e.g., ages, occupations, marital status, etc.), and other data characterizing the relationship between the particular customer and the financial institution. Further, profile data 112A may also include, for the particular customer, multiple data records that include corresponding elements of temporal data (e.g., a time or date stamp, etc.), and the multiple data records may establish, for the particular customer, a temporal evolution in the customer residence or a temporal evolution in one or more of the demographic parameter values.

Account data 1128 may also include a plurality of data records that identify and characterize one or more financial products or financial instruments issued by the financial institution to corresponding ones of the customers. For example, the data records of account data 112B may include, for each of the financial products issued to corresponding ones of the customers, one or more identifiers of the financial product or instrument (e.g., an account number, expiration data, card-security-code, etc.), one or more unique customer identifiers (e.g., an alphanumeric character string, such as a login credential, a customer name, etc.), and additional information characterizing a balance or current status of the financial product or instrument (e.g., payment due dates or amounts, delinquent accounts statuses, etc.).

Examples of these financial products or financial instruments may include, but are not limited to, one or more deposit accounts issued to corresponding ones of the customers (e.g., a savings account, a checking account, etc.), one or more brokerage or retirements accounts issued to corresponding ones of the customers by the financial institutions, and one or more secured credit products issued to corresponding ones of the customers by the financial institution (e.g., a home mortgage, a home-equity line-of-credit (HELOC), an auto loan, etc.). The financial products or financial instruments may also include one or more unsecured credit products issued to corresponding ones of the customers by the financial institution, and examples of these unsecured credit products may include, but are not limited to, a credit-card account, a personal loan, or an unsecured line-of-credit.

Further, transaction data 112C may include data records that identify, and characterize one or more initiated, settled, or cleared transactions involving respective ones of the customers and corresponding ones of the issued financial products, including the unsecured credit products described herein. Examples of these transactions include, but are not limited to, purchase transactions, bill-payment transactions, electronic funds transfers, currency conversions, purchases of securities, derivatives, or other tradeable instruments, electronic funds transfer (EFT) transactions, peer-to-peer (P2P) transfers or transactions, or real-time payment (RTP) transactions. For instance, and for a particular transaction involving a corresponding customer and corresponding financial product, the data records of transaction data 112C may include, but are limited to, a customer identifier associated with the corresponding customer (e.g., the alphanumeric character string described herein, etc.), a counterparty identifier associated with a counterparty to the particular transaction (e.g., an alphanumeric character string, a counterparty name, etc.), an identifier of the corresponding financial product (e.g., a tokenized account number, expiration data, card-security-code, etc.), and values of one or more parameters of the particular transaction (e.g., a transaction amount, a transaction date, etc.).

Further, as illustrated in FIG. 1A, source system 110B may also be associated with, or operated by, the financial institution, and may maintain, within the corresponding one or more tangible, non-transitory memories, a source data repository 113 that includes one or more additional elements of interaction data 114, which may include elements of portfolio data 114A, redemption data 114B, and market data 114C. In some instances, portfolio data 114A may include one or more data records that identify and characterize positions in one or more mutual fund products held by corresponding customers of the financial institution. By way of example, each of the data records of portfolio data 114A may include a unique identifier of a corresponding customer of the financial institution (e.g., an alphanumeric identifier or login credential, a customer name, etc.), a unique identifier of a mutual fund product held by that corresponding customer (e.g., a fund name, etc.), positional data characterizing the position of the corresponding customer in the mutual fund product (e.g., a number of shares, a current market value of the shares, etc.), and temporal data characterizing a purchase of the mutual fund product by the corresponding customer (e.g., a purchase date or time).

Further, redemption data 114B may include one or more data records that identify and characterize occurrences of full or partial mutual-fund redemptions of mutual fund products by corresponding customers of the financial institution. By way of example, each of the data records of redemption data 114B may be associated with a corresponding, customer-specific redemption event involving a mutual fund product, and may include a unique identifier of a corresponding customer (e.g., an alphanumeric identifier or login credential, a customer name, etc.), a temporal data characterizing of the corresponding occurrence of the redemption event (e.g., a time or date, etc.), a unique identifier of a mutual fund product involving in the redemption (e.g., a fund name, etc.), characterizing the corresponding occurrence of the redemption event, such as, but not limited to, a redeemed value and indicator of a full or partial redemption, as described herein. Market data 114C may include, among other things, a current market value of each of mutual fund products offered by the financial institution and held by customers of the financial institution, along with historical data characterizing trends in the values of these mutual fund products over prior temporal intervals.

Source system 110C may also be associated with, or operated by, the financial institution, and may maintain, within the corresponding one or more tangible, non-transitory memories, a source data repository 115 that includes one or more additional elements of interaction data 116, which may include elements of engagement data 116A. In some instances, engagement data 116A may include one or more data records that identify and characterize an engagement of one or more customers with the financial institution (e.g., elements of calendar data characterizing in-person or virtual meetings between the customers and representatives the financial institution, which may be generated by an application program executed at a customer device, such as iCalendar™, Google Calendar™, Outlook, etc.), digital platforms maintained by the financial institution (e.g., web pages or mobile applications, etc.), or voice-based platforms (e.g., call centers, etc.). By way of example, each of the data records of engagement data 116A may include a unique identifier of a corresponding customer of the financial institution (e.g., an alphanumeric identifier or login credential, a customer name, etc.), temporal data characterizing the engagement, and additional information characterizing a type or duration of the engagement (e.g., interaction with a digital portal of the financial institution associated with a mutual fund product, a duration of an in-person or virtual meeting, etc.).

In some instances, FI computing system 130 may perform operations that establish and maintain one or more centralized data repositories within a corresponding one of the tangible, non-transitory memories. For example, as illustrated in FIG. 1A, FI computing system 130 may establish an aggregated data store 132, which maintains, among other things, elements of the profile, account, transaction, portfolio, redemption, engagement, and market data associated with one or more of the customers of the financial institution, which may be ingested by FI computing system 130 (e.g., from one or more of source systems 110) using any of the exemplary processes described herein. Aggregated data store 132 may, for instance, correspond to a data lake, a data warehouse, or another centralized repository established and maintained, respectively, by the distributed components of FI computing system 130, e.g., through a Hadoop™ distributed file system (HDFS).

For example, FI computing system 130 may execute one or more application programs, elements of code, or code modules that, in conjunction with the corresponding communications interface, establish a secure, programmatic channel of communication with each of source systems 110, including source systems 110A, 1106, and 110C, across network 120, and may perform operations that access and obtain all, or a selected portion, of the elements of profile, account, transaction, portfolio, engagement, and market data maintained by corresponding ones of source systems 110. As illustrated in FIG. 1A, source system 110A may perform operations that obtain all, or a selected portion, of interaction data 112, including the data records of profile data 112A, account data 1126, and transaction data 112C, from source data repository 111, and transmit the obtained portions of interaction data 112 across network 120 to FI computing system 130. Further, source system 1106 may also perform operations that obtain all, or a selected portion, of interaction data 114, including the data records of portfolio data 114A, redemption data 114B, and market data 114C, from source data repository 113, and transmit the obtained portions of interaction data 114 across network 120 to FI computing system 130. Additionally, in some instances, source system 110C may also perform operations that obtain all, or a selected portion, of interaction data 116, including the data records of engagement data 116A, from source data repository 115, and transmit the obtained portions of interaction data 116 across network 120 to FI computing system 130.

In some instances, and prior to transmission across network 120 to FI computing system 130, source system 110A, source system 1106, and source system 110C may encrypt respective portions of interaction data 112, interaction data 114, and interaction data 116 using a corresponding encryption key, such as, but not limited to, a corresponding public cryptographic key associated with FI computing system 130. Further, although not illustrated in FIG. 1A, each additional, or alternate, one of source systems 110 may perform any of the exemplary processes described herein to obtain, encrypt, and transmit additional, or alternate, portions of the profile, account, transaction, portfolio, redemption, engagement, and market data maintained locally maintained by source systems 110 across network 120 to FI computing system 130.

A programmatic interface established and maintained by FI computing system 130, such as application programming interface (API) 134, may receive the portions of interaction data 112, 114, and 116. As illustrated in FIG. 1A, API 134 may route the portions of interaction data 112 (including the data records of profile data 112A, account data 112B, and transaction data 112C), interaction data 114 (including the data records of portfolio data 114A, redemption data 114B, and market data 114C), and interaction data 116 (including the data records of engagement data 116A) to a data ingestion engine 136 executed by the one or more processors of FI computing system 130. As described herein, the portions of interaction data 112, 114, and 116 may be encrypted, and executed data ingestion engine 136 may perform operations that decrypt each of the encrypted portions of interaction data 112, 114, and 116 using a corresponding decryption key, e.g., a private cryptographic key associated with FI computing system 130.

Executed data ingestion engine 136 may also perform operations that store the portions of interaction data 112 (including the data records of profile data 112A, account data 112B, and transaction data 112C), interaction data 114 (including the data records of portfolio data 114A, redemption data 114B, and market data 114C), and interaction data 116 (including the data records of engagement data 116A) within aggregated data store 132, e.g., as ingested customer data 138. As illustrated in FIG. 1A, a pre-processing engine 140 executed by the one or more processors of FI computing system 130 may access ingested customer data 138, and perform any of the exemplary processes described herein to access elements of ingested customer data 138 (e.g., the data records of profile data 112A, account data 112B, transaction data 112C, portfolio data 114A, redemption data 114B, market data 114C, and engagement data 116A). In some instances, executed data preprocessing perform any of the exemplary data-processing operations described herein to parse the accessed elements of ingested customer data 138, to selectively aggregate, filter, and process the accessed elements of elements of ingested customer data 138, and to generate consolidated data records 142 that characterize corresponding ones of the customers, their interactions with the financial institution and with other financial institutions, and any associated redemption events during a corresponding temporal interval associated with the ingestion of interaction data 112, 114, and 116 by executed data ingestion engine 136.

Further, in some examples, executed pre-processing engine 140 may access the data records of ingested customer data 138. As described herein, each of the accessed data records may include an identifier of corresponding customer of the financial institution, such as a customer name or an alphanumeric character string, and executed pre-processing engine 140 may perform operations that map each of the accessed data records to a customer identifier assigned to the corresponding customer by FI computing system 130. By way of example, FI computing system 130 may assign a unique, alphanumeric customer identifier to each customer, and executed pre-processing engine 140 may perform operations that parse the accessed data records, identify each of the parsed data records that identifies the corresponding customer using a customer name, and replace that customer name with the corresponding alphanumeric customer identifier.

Executed pre-processing engine 140 may also perform operations that assign, to each of the accessed data records, a temporal identifier to each of the accessed data records, and that augment each of the accessed data records to include the newly assigned temporal identifier. In some instances, the temporal identifier may associate each of the accessed data records with a corresponding temporal interval, which may be indicative of reflect a regularity or a frequency at which FI computing system 130 ingests the elements of interaction data 112, 114, and 116 from corresponding ones of source systems 110. For example, executed data ingestion engine 136 may receive elements of confidential customer data from corresponding ones of source systems 110 on a monthly basis (e.g., on the final day of the month), and in particular, may receive and store the elements of interaction data 112, 114, and 116 from corresponding ones of source systems 110 on May 31, 2022. In some instances, executed pre-processing engine 140 may generate a temporal identifier associated with the regular, monthly ingestion of interaction data 112, 114, and 116 on May 31, 2022 (e.g., “2022-05-31”), and may augment the data records of ingested customer data 138 to include the generated temporal identifier. The disclosed embodiments are, however, not limited to temporal identifiers reflective of a regular, monthly ingestion of interaction data 112, interaction data 114, and interaction data 116 by FI computing system 130, and in other instances, executed pre-processing engine 140 may augment the accessed data records to include temporal identifiers reflective of any additional, or alternative, temporal interval during which FI computing system 130 ingests the elements of interaction data 112, interaction data 114, and interaction data 116.

In some instances, executed pre-processing engine 140 may perform further operations that, for a particular customer of the financial institution during the temporal interval (e.g., represented by a pair of the customer and temporal identifiers described herein), obtain one or more data records of profile data 112A, account data 112B, transaction data 112C, portfolio data 114A, redemption data 114B, market data 114C, and engagement data 116A that include the pair of customer and temporal identifiers. Executed pre-processing engine 140 may perform operations that consolidate the one or more obtained data records and generate a corresponding one of consolidated data records 142 that includes the customer identifier and temporal identifier, and that is associated with, and characterizes, the particular customer of the financial institution across the temporal intervals. By way of example, executed pre-processing engine 140 may consolidate the obtained data records, which include the pair of customer and temporal identifiers, through an invocation of an appropriate Java-based SQL “join” command (e.g., an appropriate “inner” or “outer” join command, etc.). Further, executed pre-processing engine 140 may perform any of the exemplary processes described herein to generate another one of consolidated data records 142 for each additional, or alternate, customer of the financial institution during the temporal interval (e.g., as represented by a corresponding customer identifier and the temporal interval).

Executed pre-processing engine 140 may perform operations that store each of consolidated data records 142 within one or more tangible, non-transitory memories of FI computing system 130, such as consolidated data store 144. Consolidated data store 144 may, for instance, correspond to a data lake, a data warehouse, or another centralized repository established and maintained, respectively, by the distributed components of FI computing system 130, e.g., through a Hadoop™ distributed file system (HDFS). In some instances, and as described herein, consolidated data records 142 may include a plurality of discrete data records, each of these discrete data records may be associated with, and may maintain data characterizing, a corresponding one of the customers of the financial institution during the corresponding temporal interval (e.g., a month-long interval extending from May 1, 2022, to May 31, 2022). For example, and for a particular customer of the financial institution, discrete data record 142A of consolidated data records 142 may include a customer identifier 146 of the particular customer (e.g., an alphanumeric character string “CUSTID”), a temporal identifier 148 of the corresponding temporal interval (e.g., a numerical string “2022-05-31”), and consolidated elements 150 of profile, account, transaction, portfolio, redemption, engagement, and market data that characterize the particular customer during the corresponding temporal interval (e.g., as consolidated from the data records of profile data 112A, account data 1126, transaction data 112C, portfolio data 114A, redemption data 114B, market data 114C, and/or engagement data 116A ingested by FI computing system 130 on May 31, 2022).

Further, in some instances, consolidated data store 144 may maintain each of consolidated data records 142, which characterize corresponding ones of the customers, their interactions with the financial institution and with other financial institutions, and any associated redemption events during the temporal interval, in conjunction with additional consolidated data records 152. Executed pre-processing engine 140 may perform any of the exemplary processes described herein to generate each of the additional consolidated data records 152, including based on elements of profile, account, transaction, portfolio, redemption, engagement, and market data ingested from source systems 110 during the corresponding prior temporal intervals.

Further, and as described herein, each of additional consolidated data records 152 may also include a plurality of discrete data records that are associated with and characterize a particular one of the customers of the financial institution during a corresponding one of the prior temporal intervals. For example, as illustrated in FIG. 1A, additional consolidated data records 152 may include one or more discrete data records, such as discrete data record 154, associated with a prior temporal interval extending from Apr. 1, 2022, to Apr. 30, 2022. For the particular customer, discrete data record 154 may include a customer identifier 156 of the particular customer (e.g., an alphanumeric character string “CUSTID”), a temporal identifier 158 of the prior temporal interval (e.g., a numerical string “2022-04-30”), and consolidated elements 160 of profile, account, transaction, portfolio, redemption, engagement, and market data that characterize the particular customer during the prior temporal interval extending from Apr. 1, 2022, to Apr. 30, 2022 (e.g., as consolidated from the data records ingested by FI computing system 130 on Apr. 30, 2022).

The disclosed embodiments are, however, not limited to the exemplary consolidated data records described herein, or to the exemplary temporal intervals described herein. In other examples, FI computing system 130 may generate, and the consolidated data store 144 may maintain any additional or alternate number of discrete sets of consolidated data records, having any additional or alternate composition, that would be appropriate to the elements of profile, account, transaction, portfolio, redemption, engagement, and market data ingested by FI computing system 130 at the predetermined intervals described herein. Further, in some examples, FI computing system 130 may ingest elements of profile, account, transaction, portfolio, redemption, engagement, and market data from source systems 110 at any additional, or alternate, fixed or variable temporal interval that would be appropriate to the ingested customer data or to the adaptive training of the machine learning or artificial intelligence processes described herein.

In some instances, FI computing system 130 may perform any of the exemplary operations described herein to adaptively train a machine-learning or artificial-intelligence process to predict a likelihood of an occurrence of each of a plurality of targeted redemption events involving a customer and a corresponding mutual fund during a future temporal interval using training datasets associated with a first prior temporal interval (e.g., a “training” interval), and using validation datasets associated with a second, and distinct, prior temporal interval (e.g., an out-of-time “validation” interval). As described herein, the machine-learning or artificial-intelligence process may include an ensemble or decision-tree process, such as a gradient-boosted decision-tree process (e.g., the XGBoost process), and the training and validation datasets may include, but are not limited to, values of adaptively selected features obtained, extracted, or derived from the consolidated data records maintained within consolidated data store 144, e.g., from data elements maintained within the discrete data records of consolidated data records 142 or the additional consolidated data records 152.

For example, the distributed computing components of FI computing system 130 (e.g., that include one or more GPUs or TPUs configured to operate as a discrete computing cluster) may perform any of the exemplary processes described herein to adaptively train the machine learning or artificial intelligence process (e.g., the gradient-boosted, decision-tree process) in parallel through an implementation of one or more parallelized, fault-tolerant distributed computing and analytical processes. Based on an outcome of these adaptive training processes, FI computing system 130 may generate process coefficients, parameters, thresholds, and other process parameters that collectively specify the trained machine learning or artificial intelligence process, and may store the generated process coefficients, parameters, thresholds, and process parameters within a portion of the one or more tangible, non-transitory memories, e.g., within consolidated data store 144.

Referring to FIG. 1B, a training engine 162 executed by the one or more processors of FI computing system 130 may access the consolidated data records maintained within consolidated data store 144, such as, but not limited to, the discrete data records of consolidated data records 142 or additional consolidated data records 152. As described herein, each of the consolidated data records, such as discrete data record 142A of consolidated data records 142 or discrete data record 154 of additional consolidated data records 152, may include a customer identifier of a corresponding one of the customers of the financial institution (e.g., customer identifiers 146 and 156 of FIG. 1A) and a temporal identifier that associates the consolidated data record with a corresponding temporal interval (e.g., temporal identifiers 148 and 158 of FIG. 1A). Further, as described herein, each of the accessed consolidated data records may include consolidated elements of profile, account, transaction, portfolio, redemption, engagement, and market data that characterize the corresponding one of the customers during the corresponding temporal interval (e.g., consolidated elements 150 and 160 of FIG. 1A).

In some instances, executed training engine 162 may parse the accessed consolidated data records, and based on corresponding ones of the temporal identifiers, determine that the consolidated elements of profile, account, transaction, portfolio, redemption, engagement, and market data characterize the corresponding customers across a range of prior temporal intervals. Further, executed training engine 162 may also perform operations that decompose the determined range of prior temporal intervals into a corresponding first subset of the prior temporal intervals (e.g., the “training” interval described herein) and into a corresponding second, subsequent, and disjoint subset of the prior temporal intervals (e.g., the “validation” interval described herein). For example, as illustrated in FIG. 1C, the range of prior temporal intervals (e.g., shown generally as Δt along timeline 163 of FIG. 1C) may be bounded by, and established by, temporal boundaries tᵢ and t_{f}. Further, the decomposed first subset of the prior temporal intervals (e.g., shown generally as training interval Δt_{training} along timeline 163 of FIG. 1C) may be bounded by temporal boundary tᵢ and a corresponding splitting point tₛₚₗᵢₜ along timeline 163, and the decomposed second subset of the prior temporal intervals (e.g., shown generally as validation interval Δt_{validation} along timeline 163 of FIG. 1C) may be bounded by splitting point tₛₚₗᵢₜ and temporal boundary t_{f}.

Referring back to FIG. 1B, executed training engine 162 may generate elements of splitting data 164 that identify and characterize the determined temporal boundaries of the consolidated data records maintained within consolidated data store 144 (e.g., temporal boundaries tᵢ and t_{f}) and the range of prior temporal intervals established by the determined temporal boundaries Further, the elements of splitting data 164 may also identify and characterize the splitting point (e.g., the splitting point tₛₚₗᵢₜ described herein), the first subset of the prior temporal intervals (e.g., the training interval Δt_{training} and corresponding boundaries described herein), and the second, and subsequent subset of the prior temporal intervals (e.g., the validation interval Δt_{validation} and corresponding boundaries described herein). As illustrated in FIG. 1B, executed training engine 162 may store the elements of splitting data 164 within the one or more tangible, non-transitory memories of FI computing system 130, e.g., within consolidated data store 144.

As described herein, each of the prior temporal intervals may correspond to a one-month interval, and executed training engine 162 may perform operations that establish adaptively the splitting point between the corresponding temporal boundaries such that a predetermined first percentage of the consolidated data records are associated with temporal intervals (e.g., as specified by corresponding ones of the temporal identifiers) disposed within the training interval, and such that a predetermined second percentage of the consolidated data records are associated with temporal intervals (e.g., as specified by corresponding ones of the temporal identifiers) disposed within the validation interval. For example, the first predetermined percentage may correspond to seventy percent of the consolidated data records, and the second predetermined percentage may corresponding to thirty percent of the consolidated data records, although in other examples, executed training engine 162 may compute one or both of the first and second predetermined percentages, and establish the decomposition point, based on the range of prior temporal intervals, a quantity or quality of the consolidated data records maintained within consolidated data store 144, or a magnitude of the temporal intervals (e.g., one-month intervals, two-week intervals, one-week intervals, one-day intervals, etc.).

In some examples, a training input module 166 of executed training engine 162 may perform operations that access the consolidated data records maintained within consolidated data store 144. As described herein, each of the accessed data records (e.g., the discrete data records within consolidated data records 142 or additional consolidated data records 152) characterize a customer of the financial institution (e.g., identified by a corresponding customer identifier), the interactions of the customer with the financial institution (or its digital platforms) and with mutual-fund products offered by the financial institution, and any associated redemption events involving the customer during a particular temporal interval (e.g., associated with a corresponding temporal identifier). In some instances, and based on portions of splitting data 164, executed training input module 166 may perform operations that parse the consolidated data records and determine: (i) a first subset 168A of these consolidated data records are associated with the training interval Δt_{training} and may be appropriate to training adaptively the gradient-boosted decision process during the training interval; and a (ii) second subset 168B of these consolidated data records are associated with the validation interval Δt_{validation} and may be appropriate to validating the adaptively trained gradient-boosted decision process during the validation interval.

As described herein, FI computing system 130 may perform operations that adaptively train a machine-learning or artificial-intelligence process (e.g., the gradient-boosted, decision-tree process described herein) to predict, during a current temporal interval, a likelihood of an occurrence of each of a plurality of targeted redemption events involving a customer and a corresponding mutual fund during a future temporal interval using training datasets associated with the training interval, and using validation datasets associated with the validation interval. For example, and as illustrated in FIG. 1D, the current temporal interval may be characterized by a temporal prediction point t_{pred} along timeline 163, and the executed training engine 162 may perform any of the exemplary processes described herein to train adaptively machine-learning or artificial-intelligence process (e.g., the gradient-boosted, decision-tree process described herein) to predict the likelihood of occurrences of redemption events future a future, target temporal interval Δt_{target} et based on input datasets associated with a corresponding prior extraction interval Δt_{textract}. Further, as illustrated in FIG. 1D, the target temporal interval Δt_{target} may be separated temporally from the temporal prediction point t_{pred} by a corresponding buffer interval Δt_{buffer}.

By way of example, the target temporal interval Δt_{target} may be characterized by a predetermined duration, such as, but not limited to, two months, and the prior extraction interval Δt_{extract} may be characterized by a corresponding, predetermined duration, such as a thirteen-month period. Further, in some examples, the buffer interval Δt_{buffer} may also be associated with a predetermined duration, such as, but not limited to, one month, and the predetermined duration of buffer interval Δt_{buffer} may established by FI computing system 130 to separate temporally the customers' prior interactions with the financial institution (and with other financial institutions) and redemption events from the future target temporal interval Δt_{target}.

Referring back to FIG. 1B, executed training input module 166 may perform operations that access the consolidated data records maintained within consolidated data store 144, and parse each of the consolidated data records to obtain a corresponding customer identifier (e.g., which associates with the consolidated data record with a corresponding one of the customers of the financial institution) and a corresponding temporal identifier (e.g., which associated the consolidated data record with a corresponding temporal interval). For example, and based on the obtained customer and temporal identifiers, executed training input module 166 may generate sets of segmented data records associated with corresponding ones of the customer identifiers (e.g., customer-specific sets of segmented data records), and within each set of segmented data records, executed training input module 166 may order the consolidated data records sequentially in accordance with the obtained temporal interval. Through these exemplary processes, executed training input module 166 may generate sets of customer-specific, sequentially ordered data records (e.g., data tables), which executed training input module 166 may maintain locally within the consolidated data store 144 (not illustrated in FIG. 1B).

Further, executed training input module 166 may access one or more elements of targeting data 167, which identify and characterize each of the plurality of targeted redemption events, as described herein By way of example, the elements of targeting data 167 may identify and characterize: (i) a first targeted redemption event associated with a redemption of greater than 95% of a current market value of the shares of a mutual fund product held by a customer (e.g., a “full redemption event”), (ii) a second targeted redemption event associated with a redemption of between 10% and 95% of a current market value of the shares of a mutual fund product held by a customer (e.g., a “partial redemption event”), or (iii) a third targeted redemption event associated with a redemption of less than 10% a current market value of the shares of a mutual fund product held by a customer (e.g., a “no-redemption event”). In some instances, executed training input module 166 may perform operations, consistent with the elements of targeting data 167, that augment the sequentially ordered data records within each of the customer-specific sets to include additional information characterizing a ground truth associated with the corresponding customer and temporal interval (as established by the corresponding pair of customer and temporal identifiers).

By way of example, and for a particular one of the sequentially ordered data record, such as discrete data record 142A of consolidated data records 142, executed training input module 166 may obtain customer identifier 146 (e.g., “CUSTID”), which identifies the corresponding customer, and temporal identifier 148, which indicates data record 142A is associated with May 31, 2022. Based on customer identifier 146 and temporal identifier 148, executed training input module 166 may access redemption data 114B (e.g., as maintained within consolidated data store 144), and determine whether the corresponding customer initiated one of the first, second, or third targeted redemption events involving a mutual fund product within the target interval Δt_{target} which may be separated from the temporal interval associated with the data record 142A by the corresponding buffer interval Δt_{buffer}, as described herein. Executed training input module 166 may perform operations that modify data record 142A by appending an element of ground-truth data indicative of the presence or absence of the first, second, or third targeted redemption events within the target interval Δt_{target} to consolidated data elements 150. Executed training input module 166 may also perform any of the exemplary processes described herein to generate and append an appropriate element of ground-truth data to each additional, or alternate, one of the sequentially ordered data records within each of the customer-specific sets maintained within consolidated data store 144.

Executed training input module 166 may also perform operations that partition the customer-specific sets of sequentially ordered data records into subsets suitable for training adaptively the gradient-boosted, decision-tree process (e.g., which may be maintained in first subset 168A of consolidated data records within consolidated data store 144) and for validating the adaptively trained, gradient-boosted, decision-tree process (e.g., which may be maintained in second subset 168B of consolidated data records within consolidated data store 144). By way of example, executed training input module 166 may access splitting data 164, and establish the temporal boundaries for the training interval Δt_{training} (e.g., temporal boundary tᵢ and splitting point tₛₚₗᵢₜ) and the validation interval Δt_{training} (e.g., splitting point tₛₚₗᵢₜ and temporal boundary t_{f}). Further, executed training input module 166 may also parse each of the sequentially ordered data records of the customer-specific sets, access the corresponding temporal identifier, and determine the temporal interval associated with the each of sequentially ordered data records.

If, for example, executed training input module 166 were to determine that the temporal interval associated with a corresponding one of the sequentially ordered data records is disposed within the temporal boundaries for the training interval Δt_{training}, executed training input module 166 may determine that the corresponding data record may be suitable for training, and may perform operations that include the corresponding data record within a portion of the first subset 168A (e.g., that store the corresponding data record within a portion of consolidated data store 144 associated with first subset 168A). Alternatively, if executed training input module 166 were to determine that the temporal interval associated with a corresponding one of the sequentially ordered data records is disposed within the temporal boundaries for the validation interval Δt_{validation}, executed training input module 166 may determine that the corresponding data record may be suitable for validation, and may perform operations that include the corresponding data record within a portion of the second subset 168B (e.g., that store the corresponding data record within a portion of consolidated data store 144 associated with second subset 168B). Executed training input module 166 may perform any of the exemplary processes described herein to determine the suitability of each additional, or alternate, one of the sequentially ordered data records of the customer-specific sets for adaptive training, or alternatively, validation, of the gradient-boosted, decision-tree process.

In some instances, executed training input module 166 may also perform operations that filter the consolidated data records of first subset 168A and second subset 168B in accordance with one or more filtration criteria. By way of example, the one or more filtration criteria may include a valuation-specific criterion that, when processed by executed training input module 166, causes executed training input module 166 to exclude, from first subset 168A and second subset 168B, one or more of the consolidated data records that are associated with customers holding shares of mutual funds having net-asset values of less than a predetermined threshold value. such as, but not limited to, $1,500.00. The one or more filtration criteria may also include one or more redemption-specific criteria that, when processed by executed training input module 166, causes executed training input module 166 to exclude, from first subset 168A and second subset 168B, one or more of the consolidated data records that are associated with full or partial redemptions of shares of mutual fund products having proceeds transferred to other financial products provisioned by the financial institution, or funding purchases of additional shares of the mutual fund products. The disclosed embodiments are, however, not limited to these exemplary filtration criteria, and in other instances, executed training input module 166 may apply any additional or alternate filtration criterion to the consolidated data records that would be appropriate to the customers of the financial institution, the financial institution, and the consolidated data records, and that would facilitate an adaptive training and validation of the exemplary machine-learning or artificial intelligence processes described herein.

Further, in some instances, the consolidated data records within first subset 168A and second subset 168B may represent an imbalanced data set in which the actual occurrences of full (or partial) redemption events within the target interval Δt_{target} (e.g., respective ones of the first and second targeted redemption events, as described herein) are outnumbered disproportionately by non-occurrences of redemption events within the target interval Δt_{target} (e.g., occurrences of the third targeted redemption event, as described herein), which may by established by the elements of ground-truth data appended for the consolidated data records. Based on the imbalanced character of first subset 168A and second subset 168B, executed training input module 166 may perform operations that downsample the consolidated data records within first subset 168A and second subset 168B that are associated with the actual instances of non-redemption (e.g., the third targeted redemption event, as established by the appended elements of ground-truth data), and the downsampled data records maintained within each first subset 168A and second subset 168B may represent balanced data sets characterized by a more proportionate balance between the occurrences each of the first, second, and third targeted redemption events.

Referring back to FIG. 1B, executed training input module 166 may perform operations that generate a plurality of training datasets 170 based on elements of data obtained, extracted, or derived from all or a selected portion of first subset 168A of the consolidated data records. In some instances, the plurality of training datasets 170 may, when provisioned to an input layer of the gradient-boosted decision-tree process described herein, enable executed training engine 162 to train adaptively the gradient-boosted decision-tree process to predict, during a current temporal interval, a likelihood of occurrences of redemption events involving customers of the financial institution and corresponding mutual fund products during a future temporal interval.

By way of example, each of the plurality of training datasets 170 may be associated with a corresponding one of the customers of the financial institution and a corresponding temporal interval, and may include, among other things a customer identifier associated with that corresponding customer and a temporal identifier representative of the corresponding temporal interval, as described herein. Each of the plurality of training datasets 170 may also include elements of data (e.g., feature values) that characterize the corresponding one of the customers, the corresponding customer's interaction with the financial institution or with other financial institution, and/or an occurrence (or lack thereof) of redemption events involving the corresponding customer and a corresponding mutual fund product during a temporal interval disposed prior to the corresponding temporal interval, e.g., the extraction interval Δt_{extract} described herein. Further, each of training datasets 170 may also include an element of ground-truth data, as described herein.

In some instances, executed training input module 166 may perform operations that identify, and obtain or extract, one or more of the features values from the consolidated data records maintained within first subset 168A and associated with the corresponding one of the customers. The obtained or extracted feature values may, for example, include elements of the profile, account, transaction, portfolio, redemption, engagement, and market data described herein (e.g., which may populate the consolidated data records maintained within first subset 168A). Examples of these obtained or extracted feature values may include, but are not limited to, a number of shares of a mutual fund product held by a customer, a market value of these shares, a customer age, account balances and account tenures of accounts held by a customer, rates of return for mutual fund products provisioned by the financial institution and held by a customer, rates of return for mutual fund products provisioned by the other financial institution, occurrences of types of in-person or virtual appointments involving a customer, and durations of these appointments.

Further, in some instances, executed training input module 166 may perform operations that compute, determine, or derive one or more of the features values based on elements of data extracted or obtained from the consolidated data records maintained within first subset 168A. Examples of these computed, determined, or derived feature values may include, but are not limited to, time-avenged or aggregated values of the elements of the customer profile, account, transaction, portfolio redemption, engagement, and/or market data described herein. Further, in some examples, the computed, determined, or derived feature values may also include, among other things, a value indicative of a determined trend in the parameter values within the elements of the customer profile, account, transaction, portfolio, redemption, engagement, and/or market data (e.g., a maximum or minimum value, a standard deviation from a time-averaged value, etc.), or a value of a relational feature, such as a ratio or a difference of the parameter values within elements of the customer profile, account, transaction, portfolio, redemption, engagement, and/or market data.

Executed training input module 166 may provide training datasets 170 (including the elements of ground-truth data, as described herein), and in some instances, the elements of targeting data 167, as inputs to an adaptive training and validation module 172 of executed training engine 162. Upon execution by the one or more processors of FI computing system 130, adaptive training and validation module 172 may perform operations that train adaptively the machine-learning or artificial-intelligence process in accordance with the elements of targeting data 167 and against the elements of training data included within each of training datasets 170 and corresponding elements of incorporated ground-truth data. In some examples, the distributed components of FI computing system 130 may execute adaptive training and validation module 172, and may perform any of the exemplary processes described herein in parallel to adaptively train the gradient-boosted, decision-tree process against the elements of training data included within each of training datasets 170. The parallel implementation of adaptive training and validation module 172 by the distributed components of FI computing system 130 may, in some instances, be based on an implementation, across the distributed components, of one or more of the parallelized, fault-tolerant distributed computing and analytical protocols described herein (e.g., the Apache Spark™ distributed, cluster-computing framework, etc.).

By way of example, the machine-learning or artificial-intelligence process may include an ensemble or decision-tree process, such as a gradient-boosted decision-tree process (e.g., an XGBoost process), and executed adaptive training and validation module 172 may perform operations establish a plurality of nodes and a plurality of decision trees for the gradient-boosted, decision-tree process, which may ingest and process the elements of training data (e.g., the customer identifiers, the temporal identifiers, the feature values, etc.) maintained within each of the plurality of training datasets 170. Based on the execution of adaptive training and validation module 172, and on the ingestion of each of training datasets 170 by the established nodes of the gradient-boosted, decision-tree process, FI computing system 130 may perform operations that adaptively train the gradient-boosted, decision-tree process in accordance with the elements of targeting data 167 and against the elements of training data included within each of training datasets 170 and corresponding elements of the incorporated ground-truth data. In some examples, during the adaptive training of the gradient-boosted, decision-tree process, executed adaptive training and validation module 172 may perform operations that characterize a relative of importance of discrete features within one or more of training datasets 170 through a generation of corresponding Shapley feature values and through a generation of values of probabilistic metrics that average a computed area under curve for receiver operating characteristic (ROC) curves across corresponding pairs of the targeted classes of redemption events, such as, but limited to a value of a multiclass, one-versus-all area under curve (MAUC) computed for one or more of the training datasets.

Through the performance of these adaptive training processes, executed adaptive training and validation module 172 may compute one or more candidate process parameters that characterize the adaptively trained, gradient-boosted, decision-tree process, and package the candidate process parameters into corresponding portions of candidate process data 174. In some instances, the candidate process parameters included within candidate process data 174 may include, but are not limited to, a learning rate associated with the adaptively trained, gradient-boosted, decision-tree process, a number of discrete decision trees included within the adaptively trained, gradient-boosted, decision-tree process (e.g., the “n_estimator” for the adaptively trained, gradient-boosted, decision-tree process), a tree depth characterizing a depth of each of the discrete decision trees included within the adaptively trained, gradient-boosted, decision-tree process, a minimum number of observations in terminal nodes of the decision trees, and/or values of one or more hyperparameters that reduce potential process overfitting (e.g., regularization of pseudo-regularization hyperparameters). Further, and based on the performance of these adaptive training processes, executed adaptive training and validation module 172 may also generate candidate input data 176, which specifies a candidate composition of an input dataset for the adaptively trained, gradient-boosted, decision-tree process (e.g., which be provisioned as inputs to the nodes of the decision trees of the adaptively trained, gradient-boosted, decision-tree process).

As illustrated in FIG. 1B, executed adaptive training and validation module 172 may provide candidate process data 174 and candidate input data 176 as inputs to executed training input module 166 of training engine 162, which may perform any of them exemplary processes described herein to generate a plurality of validation datasets 178 having compositions consistent with candidate input data 176, and to generate an element of ground-truth data associated with each of the plurality of validation datasets 178 and to append the elements of ground-truth data to corresponding ones of validation datasets 178. As described herein, the plurality of validation datasets 178 may, when provisioned to, and ingested by, the nodes of the decision trees of the adaptively trained, gradient-boosted, decision-tree process, enable executed training engine 162 to validate the predictive capability and accuracy of the adaptively trained, gradient-boosted, decision-tree process, for example, based on elements of ground truth data incorporated within the validation datasets 178, or based on one or more computed metrics, such as, but not limited to, computed precision values, computed recall values, computed areas under curve (AUCs) for receiver operating characteristic (ROC) curves or precision-recall (PR) curves, and/or computed multiclass, one-versus-all areas under curve (MAUC) for ROC curves.

By way of example, executed training input module 166 may parse candidate input data 176 to obtain the candidate composition of the input dataset, which not only identifies the candidate elements of customer-specific data included within each validation dataset (e.g., the candidate feature values described herein), but also a candidate sequence or position of these elements of customer-specific data within the validation dataset. Examples of these candidate feature values include, but are not limited to, one or more of the feature values extracted, obtained, computed, determined, or derived by executed training input module 166 and packaged into corresponding portions of training datasets 170, as described herein.

Further, in some examples, each of the plurality of validation datasets 178 may be associated with a corresponding one of the customers of the financial institution, and with a corresponding temporal interval within the validation interval Δt_{validation}, and executed training input module 166 may access the consolidated data records maintained within second subset 168B of consolidated data store 144, and may perform operations that extract, from an initial one of the consolidated data records, a customer identifier (which identifies a corresponding one of the customers of the financial institution associated with the initial one of the consolidated data records) and a temporal identifier (which identifies a temporal interval associated with the initial one of the consolidated data records). Executed training input module 166 may package the extracted customer identifier and temporal identifier into portions of a corresponding one of validation datasets 178, e.g., in accordance with candidate input data 176.

Executed training input module 166 may perform operations that access one or more additional ones of the consolidated data records that are associated with the corresponding one of the customers (e.g., that include the customer identifier) and as associated with a temporal interval (e.g., based on corresponding temporal identifiers) disposed prior to the corresponding temporal interval, e.g., within the extraction interval Δt_{extract} described herein. Based on portions of candidate input data 176, executed training input module 166 may identify, and obtain or extract one or more of the feature values of the validation datasets from within the additional ones of the consolidated data records within second subset 168B. Further, in some examples, and based on portions of candidate input data 176, executed training input module 166 may perform operations that compute, determine, or derive one or more of the features values based on elements of data extracted or obtained from further ones of the consolidated data records within second subset 168B. Executed training input module 166 may package each of the obtained, extracted, computed, determined, or derived feature values into corresponding positions within the initial one of validation datasets 178, e.g., in accordance with the candidate sequence or position specified within candidate input data 176.

Further, executed training input module 166 may package, into an appropriate position within portion of the corresponding one of validation datasets 178, an element of ground-truth data indicative of an occurrence of the first, second, or third targeted redemption events associated with the corresponding one of the customers within a two-month period deposed within one and three months subsequent to the corresponding temporal interval. For example, executed training input module 166 may parse the initial one of the consolidated data records, extract the element of ground-truth data, and package the extracted element of ground-truth data into the appropriate position within the corresponding one of validation datasets 178, e.g., in accordance with the candidate sequence or position specified within candidate input data 176.

In some instances, executed training input module 166 may perform any of the exemplary processes described herein to generate additional, or alternate, ones of validation datasets 178 based on the elements of data maintained within the consolidated data records of second subset 168B. For example, each of the additional, or alternate, ones of validation datasets 178 may associated with a corresponding, and distinct, pair of customer and temporal identifiers, and as such, corresponding customers of the financial institution and corresponding temporal intervals within validation interval Δt_{validation}. Further, executed training input module 166 may perform any of the exemplary processes described herein to generate an additional, or alternate, ones of validation datasets 178 associated with each unique pair of customer and temporal identifiers maintained within the consolidated data records of second subset 168B, and in other instances a number of discrete validation datasets within validation datasets 178 may be predetermined or specified within candidate input data 176.

Referring back to FIG. 1B, executed training input module 166 may provide the plurality of validation datasets 178 (including the elements of ground-truth data, as described herein), and in some instances, the elements of targeting data 167, as inputs to executed adaptive training and validation module 172. In some examples, executed adaptive training and validation module 172 may perform operations that apply the adaptively trained, gradient-boosted, decision-tree process to respective ones of validation datasets 178 (e.g., based on the candidate process parameters within candidate process data 174, as described herein), and that generate elements of output data based on the application of the adaptively trained, gradient-boosted, decision-tree process to corresponding ones of validation datasets 178.

As described herein, each of the each of elements of output data may be generated through the application of the adaptively trained, gradient-boosted, decision-tree process to a corresponding one of validation datasets 178. Further, as described herein, each of elements of output data may include a numerical value indicative of a predicted likelihood of an occurrence of each of the targeted redemption events involving, or associated with, a corresponding one of the customers during the target interval Δt_{target}. In some instances, each of the numerical values may range from zero (e.g., indicative of a minimal predicted likelihood) to unity (e.g., indicative of a maximum predicted likelihood), and the numerical values characterizing the predicted likelihoods of the occurrences of the first, second, and third targeted redemption events involving the corresponding one of the customers during the target interval Δt_{target} may sum to unity.

Executed adaptive training and validation module 172 may perform operations that compute a value of one or more metrics that characterize a predictive capability, and an accuracy, of the adaptively trained, gradient-boosted, decision-tree process based on the generated elements of output data and corresponding ones of validation datasets 178. The computed metrics may include, but are not limited to, one or more recall-based values for the adaptively trained, gradient-boosted, decision-tree process (e.g., “recall@5,” “recall@10,” “recall@20,” etc.), and additionally, or alternatively, one or more precision-based values for the adaptively trained, gradient-boosted, decision-tree process. Further, in some examples, the computed metrics may include a computed value of an area under curve (AUC) for a precision-recall (PR) curve associated with the adaptively trained, gradient-boosted, decision-tree process, computed value of an AUC for a receiver operating characteristic (ROC) curve associated with the adaptively trained, gradient-boosted, decision-tree process, and additionally, or alternatively, a computed value of multiclass, one-versus-all area under curve (MAUC) for a ROC curve across the corresponding pairs of the targeted classes of redemption events associated with the adaptively trained, gradient-boosted, decision-tree process. The disclosed embodiments are, however, not limited to these exemplary computed metric values, and in other instances, executed adaptive training and validation module 172 may compute a value of any additional, or alternate, metric appropriate to validation datasets 178, the elements of ground-truth data, or the adaptively trained, gradient-boosted, decision-tree process

In some examples, executed adaptive training and validation module 172 may also perform operations that determine whether all, or a selected portion of, the computed metric values satisfy one or more threshold conditions for a deployment of the adaptively trained, gradient-boosted, decision-tree process and a real-time application to elements of customer profile, account, transaction, portfolio redemption, or engagement data, as described herein. For instance, the one or more threshold conditions may specify one or more predetermined threshold values for the adaptively trained, gradient-boosted, decision-tree mode, such as, but not limited to, a predetermined threshold value for the computed recall-based values, a predetermined threshold value for the computed precision-based values, and/or a predetermined threshold value for the computed AUC values. In some examples, executed adaptive training and validation module 172 that establish whether one, or more, of the computed recall-based values, the computed precision-based values, the computed AUC values, and/or the computed MAUC values exceed, or fall below, a corresponding one of the predetermined threshold values and as such, whether the adaptively trained, gradient-boosted, decision-tree process satisfies the one or more threshold requirements for deployment.

If, for example, executed adaptive training and validation module 172 were to establish that one, or more, of the computed metric values fail to satisfy at least one of the threshold requirements, FI computing system 130 may establish that the adaptively trained, gradient-boosted, decision-tree process is insufficiently accurate for deployment and a real-time application to the elements of profile, account, transaction, portfolio, redemption, engagement, and market data described herein. Executed adaptive training and validation module 172 may perform operations (not illustrated in FIG. 1B) that transmit data indicative of the established inaccuracy to executed training input module 166, which may perform any of the exemplary processes described herein to generate one or more additional training datasets and to provision those additional encrypted training datasets to executed adaptive training and validation module 172. In some instances, executed adaptive training and validation module 172 may receive the additional training datasets, and may perform any of the exemplary processes described herein to train further the gradient-boosted, decision-tree process against the elements of training data included within each of the additional training datasets.

Alternatively, if executed adaptive training and validation module 172 were to establish that each computed metric value satisfies threshold requirements, FI computing system 130 may deem the gradient-boosted, decision-tree process adaptively trained, and ready for deployment and real-time application to the elements of profile, account, transaction, portfolio, redemption, engagement, and market data described herein. In some instances, executed adaptive training and validation module 172 may generate process parameter data 180 that includes the process parameters of the adaptively trained, gradient-boosted, decision-tree process, such as, but not limited to, each of the candidate process parameters specified within candidate process data 174. Further, executed adaptive training and validation module 172 may also generate process input data 182, which characterizes a composition of an input dataset for the adaptively trained, gradient-boosted, decision-tree process and identifies each of the discrete data elements within the input dataset, along with a sequence or position of these elements within the input dataset (e.g., as specified within candidate input data 176). As illustrated in FIG. 1B, executed adaptive training and validation module 172 may perform operations that store process parameter data 180 and process input data 182 within the one or more tangible, non-transitory memories of FI computing system 130, such as consolidated data store 144.

Further, in some examples, executed adaptive training and validation module 172 may also perform operations that generate one or more elements of explainability data 184 that, among other things, characterize a contribution of each of the discrete feature values specified within process input data 182 to: the predicted likelihood of the occurrence of the first targeted redemption event involving customers of the financial institution during the target interval Δt_{target} (e.g., first subset 186 of FIG. 1B); the predicted likelihood of the occurrence of the second targeted redemption event involving the customers during the target interval Δt_{target} (e.g., second subset 188 of FIG. 1B); and the predicted likelihood of the occurrence of the third targeted redemption event involving the customers during the target interval Δt_{target} (e.g., third subset 190 of FIG. 1B). By way of example, executed adaptive training and validation module 172 may perform operations that compute the relative contribution and importance of each of the discrete features to the predicted likelihoods of the occurrences of respective ones of the first, second, and third targeted redemption events (e.g., the full redemption event, the partial redemption event, and the non-occurrence of any redemption event) based on a determined number of branching points that utilize the corresponding feature, based on a computed Shapley feature value for the corresponding feature, or based on any additional or alternate, metric indicative of the contribution of the corresponding feature to the predicted likelihoods of the occurrences of respective ones of the first, second, and third targeted redemption events. As illustrated in FIG. 1B, executed training engine 162 may store explainability data 184, including subsets 186, 188, and 190 that characterize contribution and importance of each of the discrete features specified within process input data 182 to the predicted likelihoods of the occurrences of respective ones of the first, second, and third targeted redemption events, within the one or more tangible, non-transitory memories of FI computing system 130, such as consolidated data store 144.

### B. Exemplary Processes for Predicting Future Occurrences of Targeted Redemption Events Using Trained, Machine-Learning or Artificial-Intelligence Processes

In some examples, one or more computing systems associated with or operated by a financial institution, such as one or more of the distributed components of FI computing system 130, may perform operations that adaptively train a machine learning or artificial intelligence process to predict, during a current temporal interval, a likelihood of an occurrence of each of a plurality of targeted redemption events involving a customer and a mutual fund product during a future temporal interval using training data associated with a first prior temporal interval, and using validation data associated with a second, and distinct, prior temporal interval. As described herein, the machine-learning or artificial-intelligence process may include an ensemble or decision-tree process, such as a gradient-boosted, decision-tree process, and the training and validation data may include, but are not limited to, elements of profile, account, transaction, portfolio, redemption, engagement, and market data characterizing corresponding ones of the customers of the financial institution holding with a position in one or more mutual funds that exceed a predetermined value (e.g., $1,500, etc.), along with elements of redemption data identifying and characterizing prior occurrences of redemption events associated with, or involving, the corresponding customers (e.g., that exclude redemptions that fund purchase of other investment products offered by the financial institution or a repurchase of additional mutual funds offered by the financial institution).

In some instances, FI computing system 130 may perform any of the exemplary processes described herein to generate input datasets associated with all, or a selected subset, of the customers of the financial institution that hold a position in one or more mutual funds valued in excess of a predetermined value (e.g., $1,500, etc.), and to apply the adaptively trained machine-learning or artificial-intelligence process, such as the adaptively trained, gradient-boosted, decision-tree process described herein, to each of the input datasets. Based on the application of the adaptively trained machine-learning or artificial-intelligence process to each of the input datasets, FI computing system 130 may perform any of the exemplary processes described herein to generate corresponding elements of output data, each of which may indicate of a predicted likelihood of an occurrence of each of the targeted redemption events involving a corresponding customer and mutual fund product during a future temporal interval, such as, but not limited to, two-month interval between one and three months from a corresponding prediction date. In some instances, and for each of the customers, the output data may include a numerical values indicative of a likelihood of each of (i) an occurrence of a full redemption event involving the mutual fund product (e.g., a redemption of greater than 95% of a current market value of the mutual fund); (ii) an occurrence of a partial redemption event involving the mutual fund product (e.g., a redemption of between 10% and 95% of the current market value); and (ii) a non-occurrence of a redemption event involving the mutual fund product (e.g., a redemption of less than 10% of the current market value). Further, and as described herein, the numerical values characterizing the predicted likelihoods of the occurrence of the full redemption event, the partial redemption event, and the non-occurrence of the redemption event (e.g., the occurrences of the first, second, and third redemption events, respectively) during the target interval Δt_{target} may sum to unity.

Certain of these exemplary processes, which adaptively train and validate a gradient-boosted, decision-tree process using customer-specific training and validation datasets associated with respective training and validation periods, and which apply the trained and validated gradient-boosted, decision-tree process to additional customer-specific input datasets, may enable the one or more of the FI computing systems to predict, in real-time, a likelihood of an occurrence of each of the target redemption event involving one or more customers of the financial institution and corresponding mutual funds products during a predetermined, future temporal interval (e.g., via an implementation of one or more parallelized, fault-tolerant distributed computing and analytical protocols across clusters of graphical processing units (GPUs) and/or tensor processing units (TPUs)). These exemplary processes may, for example, be implemented by the one or more computing systems of the financial institution in addition to, or as alternative to, exiting subjective, rules based processes for identifying customers that represent likely candidate for involvement in future redemption events

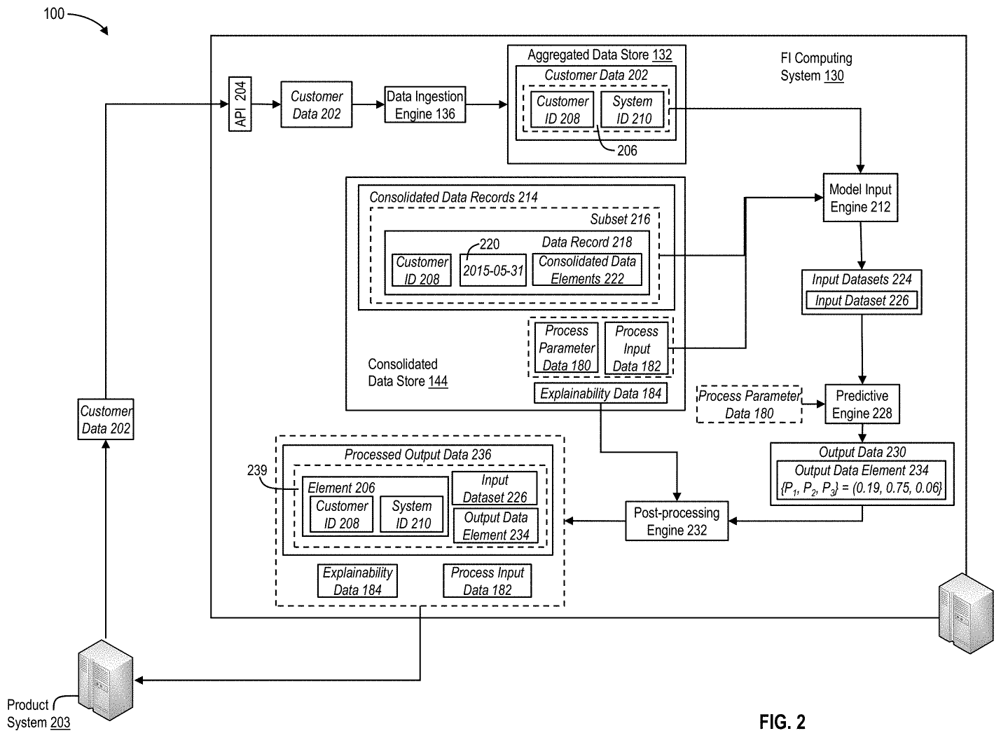

Referring to FIG. 2, aggregated data store 132 of FI computing system 130 may maintain one or more elements of customer data 202. In some instances, each of the one or more elements of customer data 202 may be associated with a customer of the financial institution that holds a position in one or more mutual funds having a value in excess of a predetermined threshold (e.g., greater than $1,500 in a corresponding mutual-fund account). FI computing system 130 may, for example, receive all, or a selected portion, of customer data elements 202 from a product system 203 associated with that financial institution that manages, administers, or offers for sale to the customers of the financial institution shares of the one or more mutual funds.

In some instances, product system 203, may represent a computing system that includes one or more servers and tangible, non-transitory memories storing executable code and application modules. Further, the one or more servers may each include one or more processors (such as a central processing unit (CPU)), which may be configured to execute portions of the stored code or application modules to perform operations consistent with the disclosed embodiments. Product system 203 may also include a communications interface, such as one or more wireless transceivers, coupled to the one or more processors for accommodating wired or wireless internet communication with other computing systems and devices operating within environment 100. In some instances, product system 203 may be incorporated into a discrete computing system, although in other instances, product system 203 may correspond to a distributed computing system having a plurality of interconnected, computing components distributed across an appropriate computing network, such as communications network 120 of FIG. 1A, or to a publicly accessible, distributed or cloud-based computing cluster, such as a computing cluster maintained by Microsoft Azure™, Amazon Web Services™ Google Cloud™, or another third-party provider.

Referring back to FIG. 2, an application program executed by the one or more processors of product system 203 may transmit portions of customer data 202 across network 120 to FI computing system 130 in accordance with a predetermined temporal schedule, e.g., at a predetermined time on a daily basis. The transmitted portions may be encrypted using a corresponding encryption key, such as a public cryptographic key associated with FI computing system 130, and a programmatic interface established and maintained by FI computing system 130, such as application programming interface (API) 204, may receive the portions of customer data 202 from product system 203. API 204 may, for example, route each of the elements of customer data 202 to executed data ingestion engine 136, which may perform operations that store the elements of customer data 202 within one or more tangible, non-transitory memories of FI computing system 130, such as within aggregated data store 132.

In some instances, and as described herein, the received elements of customer data 202 may be encrypted, and executed data ingestion engine 136 may perform operations that decrypt each of the encrypted elements of customer data 202 using a corresponding decryption key (e.g., a private cryptographic key associated with FI computing system 130) prior to storage within aggregated data store 132. Further, although not illustrated in FIG. 2, aggregated data store 132 may also store one or more additional elements of customer data identifying customers of the financial institution that hold corresponding ones of the mutual fund products, and executed data ingestion engine 136 may perform one or more synchronization operation that merge the received elements of customer data 202 with the previously stored elements of customer data, and that eliminate any duplicate elements existing among the received elements of customer data 202 with the previously stored elements of customer data (e.g., through an invocation of an appropriate Java-based SQL “merge” command).

As described herein, each of the elements of customer data 202 may be associated with, and include a unique identifier of, a customer of the financial institution that holds at least the predetermined position in the one or more mutual fund products. For example, as illustrated in FIG. 2, element 206 of customer data 202, which may be associated with a particular one of the customers and received from product system 203, may include a customer identifier 208 assigned to the particular customer by FI computing system 130 (e.g., an alphanumeric character string, etc.), and a system identifier 210 associated with product system 203 (e.g., an Internet Protocol (IP) address, a media access control (MAC) address, etc.).

FI computing system 130 may perform any of the exemplary processes described herein to generate an input dataset associated with each of the customers identified by the discrete elements of customer data 202, and to apply the adaptively trained, gradient-boosted, decision-tree process described herein to each of the input datasets, in accordance with a predetermined temporal schedule (e.g., on a daily basis at a predetermined time, etc.), or in response to a detection of a triggering event. By way of example, and without limitation, the triggering event may correspond to a detected change in a composition of the elements of customer data 202 maintained within aggregated data store (e.g., to an ingestion of additional elements of customer data 202, etc.) or to a receipt of an explicit request received from product system 203.

In some instances, and in accordance with the predetermined temporal schedule, or upon detection of the triggering event, a process input engine 212 executed by FI computing system 130 may perform operations that access the elements of customer data 202 maintained within aggregated data store 132, and that obtain the customer identifier maintained within a corresponding one of the accessed elements of customer data 202. For example, as illustrated in FIG. 2, executed process input engine 212 may access element 206 of customer data 202 (e.g., as maintained within aggregated data store 132) and obtain customer identifier 208, which includes, but is not limited to, the alphanumeric character string assigned to the particular customer of the financial institution.

Executed process input engine 212 may also access consolidated data store 144, and perform operations that identify, within consolidated data records 214, a subset 216 of consolidated data records that include customer identifier 208 and as such, are associated with the particular customer of the financial institution identified by element 206 of customer data 202. As described herein, each of consolidated data records 214 may be associated with a customer of the financial institution, and may characterize that customer, the interaction of and engagement of that customer with the financial institution, and any associated redemption events involving that customer during a corresponding temporal interval. For example, and as described herein, each of consolidated data records 214 may include a corresponding customer identifier (e.g., an alphanumeric character string assigned to a corresponding customer), a corresponding temporal identifier (e.g., that identifies the corresponding temporal interval), and one or more consolidated data elements associated with the corresponding customer. Examples of these consolidated data elements may include, but are not limited to, elements profile data, account data, transaction data, portfolio data, redemption data, or engagement data, which may be ingested, processed, aggregated, or filtered by FI computing system 130 using any of the exemplary processes described herein.

In some instances, and as illustrated in FIG. 2, each of subset 216 may include customer identifier 208 and as such, may be associated with the particular customer identified by element 206 of customer data 202. Each of subset 216 of consolidated data records 214 may also include a temporal identifier of a corresponding temporal interval, and one or more consolidated elements associated with the particular customer, the interaction of and engagement of the particular customer with the financial institution and with other financial institutions, and any associated redemption events involving the particular customer during corresponding ones of the temporal intervals. By way of example, data record 218 of subset 216 may include customer identifier 208, a corresponding temporal identifier 220 (e.g., “2022-05-31,” indicating a temporal interval spanning May 1, 2022, through May 31, 2022), and consolidated data elements 222, which identify and characterize the particular customer during the temporal interval spanning May 1, 2022, through May 31, 2022. Further, although not illustrated in FIG. 2, each additional, or alternate, data records within subset 216 may include customer identifier 208, a temporal identifier of a corresponding temporal interval, and corresponding elements of consolidated data that identify and characterize the particular customer during the corresponding temporal interval.

Executed process input engine 212 may also perform operations that obtain, from consolidated data store 144, elements of process input data 182 characterize a composition of an input dataset for the adaptively trained, gradient-boosted, decision-tree process. In some instances, executed process input engine 212 may parse process input data 182 to obtain the composition of the input dataset, which not only identifies the elements of customer-specific data included within each input dataset (e.g., input feature values, as described herein), but also a specified sequence or position of these input feature values within the input dataset. Examples of these input feature values include, but are not limited to, one or more of the candidate feature values extracted, obtained, computed, determined, or derived by executed training input module 166 and packaged into corresponding portions of training datasets 170, as described herein.

In some instances, and based on the parsed portions of process input data 182, executed process input engine 212 may that identify, and obtain or extract, one or more of the input feature values from one or more of data records maintained within subset 216 of consolidated data records 214 and associated with temporal intervals disposed within the extraction interval Δt_{extract}, as described herein. Executed process input engine 212 may perform operations that package the obtained, or extracted, input feature values within a corresponding one of input datasets 224, such as input dataset 226 associated with the particular customer identified by element 206 of customer data 202, in accordance with their respective, specified sequences or positions. Further, in some examples, and based on the parsed portions of process input data 182, executed process input engine 212 may perform operations that compute, determine, or derive one or more of the input features values based on elements of data extracted or obtained from the additional ones of the consolidated data records, as described herein. Executed process input engine 212 may perform operations that package each of the computed, determined, or derived input feature values into portions of input datasets 226 in accordance with their respective, specified sequences or positions.

Through an implementation of these exemplary processes, executed process input engine 212 may populate an input dataset associated with the particular customer identified by element 206 of customer data 202, such as input dataset 226 of input datasets 224, with input feature values obtained or extracted from, or computed, determined or derived from element of data within, the data records of subset 216 (such as, but not limited to, the exemplary feature values described herein). Further, in some instances, executed process input engine 212 may also perform any of the exemplary processes described herein to generate, and populate with input feature values, an additional one of input datasets 224 for each of the additional, or alternate, customers of the financial institution associated with additional, or alternate, elements of customer data 202. Executed process input engine 212 may package each of the discrete, customer-specific input datasets within input datasets 224, and executed process input engine 212 may provide input datasets 224 as an input to a predictive engine 228 executed by the one or more processors of FI computing system 130.

As illustrated in FIG. 2, executed predictive engine 228 may perform operations that obtain, from consolidated data store 144, process parameter data 180 that includes one or more process parameters of the adaptively trained, gradient-boosted, decision-tree process. For example, and as described herein, the process parameters included within process parameter data 180 may include, but are not limited to, a learning rate associated with the adaptively trained, gradient-boosted, decision-tree process, a number of discrete decision trees included within the adaptively trained, gradient-boosted, decision-tree process (e.g., the “n_estimator” for the adaptively trained, gradient-boosted, decision-tree process), a tree depth characterizing a depth of each of the discrete decision trees included within the adaptively trained, gradient-boosted, decision-tree process, a minimum number of observations in terminal nodes of the decision trees, and/or values of one or more hyperparameters that reduce potential process overfitting (e.g., regularization of pseudo-regularization hyperparameters).

In some examples, and based on portions of process parameter data 180, executed predictive engine 228 may perform operations that establish a plurality of nodes and a plurality of decision trees for the adaptively trained, gradient-boosted, decision-tree process, each of which receive, as inputs (e.g., “ingest”), corresponding elements of input datasets 224. Further, and based on the execution of predictive engine 228, and on the ingestion of input datasets 224 by the established nodes and decision trees of the adaptively trained, gradient-boosted, decision-tree process, FI computing system 130 may perform operations that apply the adaptively trained, gradient-boosted, decision-tree process to each of the input datasets of input datasets 224, including input dataset 226, and that generate an element of output data 230 associated with a corresponding one of input datasets 224, and as such, a corresponding one of the customers identified by the elements of customer data 202.

As described herein, each of the generated elements of output data 230 may include a numerical score indicative of a predicted likelihood that the corresponding one of the customers will be involved in each of an occurrence of a full redemption event, an occurrence of a partial redemption event, or a non-occurrence of a redemption event during the future temporal interval (e.g., an occurrence of respective ones of the first, second, and third targeted redemption events during the target interval Δt_{target}, described herein). In some examples, the numerical scores associated with the occurrence of the full redemption event, the occurrence of the partial redemption event, or the non-occurrence of the redemption event within each of the elements of output data 230 may range from zero to unity, with zero being indicative of a minimal predicted likelihood, and unity being indicative of a maximum predicted likelihood, and as described herein, the numerical scores may sum to unity for each of the customers.

As illustrated in FIG. 2, executed predictive engine 228 may provide the generated elements of output data 230 (e.g., either alone, or in conjunction with corresponding ones of input datasets 224) as an input to a post-processing engine 232 executed by the one or more processors of FI computing system 130. In some instances, and upon receipt of the generated elements of output data 230 (e.g., and additionally, or alternatively, the corresponding ones of input datasets 224), executed post-processing engine 232 may perform operations that access the elements of customer data 202 maintained within consolidated data store 144, and associate each of the elements of customer data 202 (e.g., that identify a corresponding one of the customers of the financial institution that hold a mutual fund product) with a corresponding one of the elements of output data 230 (e.g., that include numerical scores indicative of the predicted likelihood that corresponding ones of the customers will be involved in full, partial, or no redemption events during the future temporal interval), and to a corresponding one of input datasets 224 (which include the feature values).

By way of example, element 234 of output data 230 may be associated with the particular customer identified by element 206 of customer data 202, and executed post-processing engine 232 may, in some instances, associate element 206 of customer data 202 with element 234 of output data 230 and with input dataset 226 of input datasets 224. In some instances, element 234 of output data 230 may include: (i) a first numerical value P₁ indicating a predicted likelihood that the particular customer will initiate a full redemption event involving the shares held in the mutual fund product (e.g., will be involved in an occurrence of the first targeted redemption event) during the future temporal interval; (ii) a second numerical value P₂ indicating a predicted likelihood that the particular customer will initiate a partial redemption event involving the shares held in the mutual fund product (e.g., e.g., will be involved in an occurrence of the second targeted redemption event) during the future temporal interval; and a third numerical value P₃ indicating a predicted likelihood that the particular customer will be involved in a non-occurrence of a redemption event involving the shared held mutual fund product (e.g., will be involved in an occurrence of the third targeted redemption event) during the future temporal interval. As described herein, each of numerical values P₁, P₂, P₃ may range between zero and unity, and in some instances, numerical values P₁, P₂, P₃ may sum to unity.

Further, as illustrated in FIG. 2, elements 234 may maintain numerical values P₁, P₂, P₃, which characterize the predicted likelihoods of the occurrences of the first, second, and third targeted redemption events involving the particular customer during the future temporal interval, within a linear array, e.g., {P₁, P₂, P₃} having indices corresponding, respectively, to the first, second, and third targeted redemption events within specified within targeting data 167. For example, element 234 of output data 230 may include a linear array {0.19, 0.75, and 0.06}, which indicates a 19% probability that the particular customer will initiate a full redemption event involving shares valued at greater than 95% of a current market value of the mutual fund product (e.g., the first targeted redemption event, described herein), a 75% probability the particular customer will initiate a partial redemption event involving shares valued at between with 10% and 95% of the current market value of the mutual fund product (e.g., the second targeted redemption event, described herein), and a 6% probability that the particular customer will initiate a redemption event involving shares valued below 10% of the current market value of the mutual fund product (e.g., the third targeted redemption event, described herein).

Executed post-processing engine 232 may perform any of these exemplary processes to associate each additional, or alternate, one of the elements of output data 230 with a corresponding one of the elements of customer data 202 and a corresponding one of input datasets 224. Executed post-processing engine 232 may also perform operations that packed linked element 206 of customer data 202 and output data element 234 into corresponding portions of processed output data 236, along with process input data 182, which characterizes a composition of an input dataset for the adaptively trained, gradient-boosted, decision-tree process and identifies each of the discrete data elements within the input dataset, along with a sequence or position of these elements within the input dataset. For example, executed post-processing engine 232 may associate element 206 of customer data 202 with element 234 of output data 230 and in some instances, with process input data 182, and may generate an element 238 of processed output data 236 that includes the associated element 206 of customer data 202, element 234 of output data 230, and in some instances, input dataset 226 and process input data 182. Executed post-processing engine 232 may also perform any of these exemplary processes to associate each additional, or alternate, one of the elements of output data 230 with a corresponding one of the elements of customer data 202, and to package each additional, or alternate, pair of the elements of customer data 202 and output data 230 (and in some instances, the corresponding into a corresponding element of processed output data 236. In some instances, executed post-processing engine 232 may also access consolidated data store 144, and obtain one or more elements of explainability data 184.

As described herein, the elements of explainability data 184 may characterize a relative contribution of each of the discrete features specified within process input data 182 to: the predicted likelihood of the occurrence of the first targeted redemption event involving customers of the financial institution during the target interval Δt_{target} (e.g., first subset 186 of explainability data 184); the predicted likelihood of the occurrence of the second targeted redemption event involving the customers during the target interval Δt_{target} (e.g., second subset 188 of explainability data 184); and the predicted likelihood of the occurrence of the third targeted redemption event involving the customers during the target interval Δt_{target} (e.g., third subset 190 of explainability data 184). In some instances, the relative contribution and importance of each of the discrete features to the predicted likelihoods of the occurrences of respective ones of the first, second, and third targeted redemption events may be determined (e.g., by executed adaptive training and validation module 172 of FIG. 1B) based on a determined number of branching points that utilize the corresponding feature, based on a computed Shapley feature value for the corresponding feature, or based on any additional or alternate, metric indicative of the contribution of the corresponding feature to the predicted likelihoods of the occurrences of respective ones of the first, second, and third targeted redemption events.

As illustrated in FIG. 2, FI computing system 130 may perform operations that transmit all, or a selected portion of, processed output data 236, including element 238 that maintains the associated pair of element 206 of customer data 202 and element 234 of output data 230, process input data 182, and the one or more elements of explainability data 184 to one or more additional computing systems operated by, or associated with, the financial institution, such as, but not limited to, product system 203. By way of example, FI computing system 130 may obtain system identifier included within each of the elements of processed output data 236 (e.g., system identifier 210 maintained within element 238 of processed output data 236), and perform operations that transmit each of the pairs of sorted and associated elements of customer data 202 and output data 230, and the one or more portions of explainability data 184 (and in some instances, process input data 182 and a corresponding one of input datasets 226), across network 120 to product system 203 associated with obtained system identifier 210. Further, although not illustrated in FIG. 2, FI computing system 130 may also encrypt all, or a selected portion of, processed output data 236 and explainability data 184 prior to transmission across network 120 using a corresponding encryption key, such as, but not limited to, a corresponding public cryptographic key associated with product system 203.

Further, although not illustrated in FIG. 2, product system 203 may receive processed output data 236, which includes the customer-specific sets of linked elements of customer data, output data elements, process input data and input datasets, and the elements of explainability data 184 from FI computing system 130 via a corresponding programmatic interface, such as an API. In some instances, processed output data 236 may be encrypted, and product system 203 may decrypt portions of processed output data 236 with a corresponding decryption key, e.g., a private cryptographic key associated with product system 203. In some examples, product system 203 may access each of the customer-specific sets of linked elements of customer data, output data elements, and input datasets maintained within processed output data 236, and may perform operations that engage, proactively, one or more of the customers (e.g., those associated with predicted occurrences of full or partial redemptions) in an attempt to prevent the predicted occurrence of one or more of the full or partial redemption events. Further, product system 203 may perform operations that generate, either alone or based on input from representatives of the financial institution, customer-specific marketing strategies based on a predicted propensity of each of the customer to fully redeem, partially redeem, or not redeem the mutual fund products, e.g., as specified by the numerical values within the customer-specific elements of processed output data 236.

By way of example, element 238 of processed output data 236 may include element 206 of customer data 202 associated with the particular customer and element 234 of output data 230, which indicates a 75% probability that the particular customer will initiate a partial redemption event involving shares valued at between with 10% and 95% of the current market value of the mutual fund product (e.g., the second targeted redemption event, described herein) during the future temporal interval. Based on the 75% probability, product system 203 may perform operations that generate one or more elements of digital content that provides an incentive for the particular customer to maintain the existing position in the shares of the mutual fund product (e.g., a predetermined number of redeemable rewards points, etc.), and may provision the digital content to a device operable by the particular customer, which may present a graphical representation of the digital content within a portion of a digital interface. Through a performance of these exemplary processes, product system 203 may enable the financial institution to engage, proactively, the particular customer associated with the expected, future partial redemption event in an attempt to prevent an occurrence of that partial redemption event during the future temporal internal.

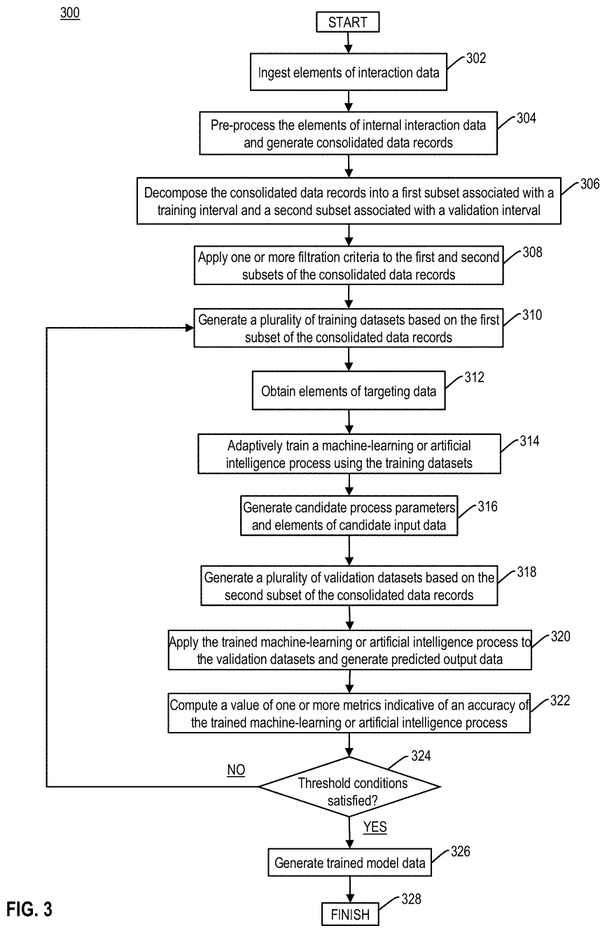

FIG. 3 is a flowchart of an exemplary process 300 for adaptively training a machine learning or artificial intelligence process to predict a likelihood of an occurrence of each of a plurality of targeted redemption events involving a customer and a corresponding mutual fund product during a future temporal interval using training datasets associated with a first prior temporal interval, and using validation datasets associated with a second, and distinct, prior temporal interval. As described herein, the machine-learning or artificial-intelligence process may include an ensemble or decision-tree process, such as a gradient-boosted decision-tree process (e.g., the XGBoost process), and the event may include, but is not limited to, a redemption event involving one or more customers of a financial institution, and the training and validation datasets may include feature values obtained, extracted, computed, or derived from the consolidated elements of profile, account, transaction, portfolio, redemption, engagement, and market data described herein. In some instances, one or more computing systems, such as, but not limited to, one or more of the distributed components of FI computing system 130, may perform one or more of the steps of exemplary process 300, as described herein.

Referring to FIG. 3, FI computing system 130 may perform any of the exemplary processes described herein to establish a secure, programmatic channel of communication with one or more source computing systems, such as source systems 110 of FIG. 1A, and to obtain, from the source computing systems, elements of internal interaction data that identify and characterize one or more customers of the financial institution (e.g., in step 302 of FIG. 3). The elements of interaction data may include, but are not limited to, one or more elements of profile, account, transaction, portfolio, redemption, engagement, and market data described herein, and FI computing system 130 may perform operations that store (or ingest) the obtained elements of interaction data within one or more accessible data repositories, such as aggregated data store 132 (e.g., also in step 302 of FIG. 3). In some instances, FI computing system 130 may perform the exemplary processes described herein to obtain and ingest the elements of elements of internal customer data in accordance with a predetermined temporal schedule (e.g., on a monthly basis), or a continuous streaming basis, across the secure, programmatic channel of communication.

Further, FI computing system 130 may access the ingested elements of internal interaction data, and may perform any of the exemplary processes described herein to pre-process the ingested elements of interaction data (e.g., the elements of profile, account, transaction, portfolio, redemption, engagement, and market data described herein) and generate one or more consolidated data records (e.g., in step 304 of FIG. 3). As described herein, the FI computing system 130 may store each of the consolidated data records within one or more accessible data repositories, such as consolidated data store 144 (e.g., also in step 304 of FIG. 3).

For example, and as described herein, each of the consolidated data records may be associated with a particular one of the customers, and may include a corresponding pair of a customer identifier associated with the particular customer (e.g., an alphanumeric character string, etc.) and a temporal interval that identifies a corresponding temporal interval. Further, and in addition to the corresponding pair of customer and temporal identifiers, each of the consolidated data records may also include one or more consolidated elements of profile, account, transaction, portfolio, redemption, engagement, and market data that characterize the particular customer, or the mutual fund products, during the corresponding temporal interval associated with the temporal identifier.

In some instances, FI computing system 130 may perform any of the exemplary processes described herein to decompose the consolidated data records into (i) a first subset of the consolidated data records having temporal identifiers associated with a first prior temporal interval (e.g., the training interval Δt_{training}, as described herein) and (ii) a second subset of the consolidated data records having temporal identifiers associated with a second prior temporal interval (e.g., the validation interval Δt_{validation}, as described herein), which may be separate, distinct, and disjoint from the first prior temporal interval (e.g., in step 306 of FIG. 3). By way of example, portions of the consolidated data records within the first subset may be appropriate to train adaptively the machine-leaning or artificial process (e.g., the gradient-boosted decision process described herein during the training interval Δt_{training}, and portions of the consolidated records within the second subset may be appropriate to validate the adaptively trained gradient-boosted decision process during the validation interval Δt_{validation}.

FI computing system 130 may also perform any of the exemplary processes described herein to filter the consolidated data records of the first and second subsets in accordance with one or more filtration criteria, such as, but not limited to, those described herein (e.g., in step 308 of FIG. 3). In some instances, FI computing system 130 may perform any of the exemplary processes described herein to generate a plurality of training datasets based on elements of data obtained, extracted, or derived from all or a selected portion of the first subset of the filtered consolidated data records (e.g., in step 310 of FIG. 3). By way of example, each of the plurality of training datasets may be associated with a corresponding one of the customers of the financial institution and a corresponding temporal interval, and may include, among other things a customer identifier associated with that corresponding customer and a temporal identifier representative of the corresponding temporal interval, as described herein. Further, and as described herein, each of the plurality of training datasets may also include elements of data (e.g., feature values) that characterize the corresponding one of the customers, the corresponding customer's interaction with the financial institution or with other financial institution, and/or an occurrence (or lack thereof) of redemption events involving the corresponding customer during a temporal interval disposed prior to the corresponding temporal interval, e.g., during the extraction interval Δt_{extract} described herein. Further, each of the plurality of training datasets may also include an element of ground-truth data indicative of the presence or absence of an actual redemption event associated with a corresponding one of the customers within a corresponding target prediction interval Δt_{target}, such as, but not limited to, a two-month period disposed between one and three months of the date specified by the temporal identifier.

Further, FI computing system 130 may also perform operations that elements of targeting data, which identify and characterize each of the plurality of targeted redemption events, as described herein (e.g., in step 312 of FIG. 3). By way of example, the elements of targeting data may identify and characterize: (i) a first targeted redemption event associated with a redemption of greater than 95% of a current market value of the shares of a mutual fund product held by a customer (e.g., a “full redemption event”), (ii) a second targeted redemption event associated with a redemption of between 10% and 95% of a current market value of the shares of a mutual fund product held by a customer (e.g., a “partial redemption event”), or (iii) a third targeted redemption event associated with a redemption of less than 10% a current market value of the shares of a mutual fund product held by a customer (e.g., a “no-redemption event”), and may include a unique, alphanumeric identifiers associated with each of the first, second, and third targeted redemption events, such, but not limited to, a value of zero, unit, and two representative of respective ones of the first, second, and third targeted redemption events.

Based on the plurality of training datasets, and in accordance with the targeting data, FI computing system 130 may also perform any of the exemplary processes described herein to train adaptively the machine-learning or artificial-intelligence process (e.g., the gradient-boosted decision-tree process described herein) to predict, during a current temporal interval, a likelihood of an occurrence of each of a plurality of targeted redemption events involving a customer and a corresponding mutual fund product during a future temporal interval (e.g., in step 314 of FIG. 3). For example, and as described herein, FI computing system 130 may perform operations that establish a plurality of nodes and a plurality of decision trees for the gradient-boosted, decision-tree process, which may ingest and process the elements of training data (e.g., the customer identifiers, the temporal identifiers, the feature values, etc.) maintained within each of the plurality of training datasets, and that adaptively train the gradient-boosted, decision-tree process against the elements of training data included within each of the plurality of the training datasets and in accordance with the elements of targeting data.

In some examples, the distributed components of FI computing system 130 may perform any of the exemplary processes described herein in parallel to establish the plurality of nodes and a plurality of decision trees for the gradient-boosted, decision-tree process, and to adaptively train the gradient-boosted, decision-tree process against the elements of training data included within each of the plurality of the training datasets. The parallel implementation of these exemplary adaptive training processes by the distributed components of FI computing system 130 may, in some instances, be based on an implementation, across the distributed components, of one or more of the parallelized, fault-tolerant distributed computing and analytical protocols described herein.

Through the performance of these adaptive training processes, FI computing system 130 may compute one or more candidate process parameters that characterize the adaptively trained machine-learning or artificial-intelligence process, such as, but not limited to, candidate process parameters for the adaptively trained, gradient-boosted, decision-tree process described herein (e.g., in step 316 of FIG. 3). In some instances, and for the adaptively trained, gradient-boosted, decision-tree process, the candidate process parameters included within candidate process data may include, but are not limited to, a learning rate associated with the adaptively trained, gradient-boosted, decision-tree process, a number of discrete decision trees included within the adaptively trained, gradient-boosted, decision-tree process (e.g., the “n_estimator” for the adaptively trained, gradient-boosted, decision-tree process), a tree depth characterizing a depth of each of the discrete decision trees included within the adaptively trained, gradient-boosted, decision-tree process, a minimum number of observations in terminal nodes of the decision trees, and/or values of one or more hyperparameters that reduce potential process overfitting (e.g., regularization of pseudo-regularization hyperparameters). Further, and based on the performance of these adaptive training processes, FI computing system 130 may perform any of the exemplary processes described herein to generate candidate input data, which specifies a candidate composition of an input dataset for the adaptively trained machine-learning or artificial intelligence process, such as the adaptively trained, gradient-boosted, decision-tree process (e.g., also in step 316 of FIG. 3).

Further, FI computing system 130 may perform any of the exemplary processes described herein to access the second subset of the consolidated data records, and to generate a plurality of validation subsets having compositions consistent with the candidate input data (e.g., in step 318 of FIG. 3). As described herein, each of the plurality of the validation datasets may be associated with a corresponding one of the customers of the financial institution, and with a corresponding temporal interval within the validation interval Δt_{validation}, and may include a customer identifier associated with the corresponding one of the customers and a temporal identifier that identifies the corresponding temporal interval. Further, each of the plurality of the validation datasets may also include one or more feature values that are consistent with the candidate input data, associated with the corresponding one of the customers, and obtained, extracted, or derived from corresponding ones of the accessed second subset of the consolidated data records (e.g., during the corresponding extraction interval Δt_{extract}, as described herein).

In some instances, FI computing system 130 may perform any of the exemplary processes described herein to apply the adaptively trained machine-learning or artificial intelligence process (e.g., the adaptively trained, gradient-boosted, decision-tree process described herein) to respective ones of the validation datasets, and to generate corresponding elements of output data based on the application of the adaptively trained machine-learning or artificial intelligence process to the respective ones of the validation datasets (e.g., in step 320 of FIG. 3). As described herein, each of the generated elements of output data may be associated with a respective one of the validation datasets and as such, a corresponding one of the customers of the financial institution. Further, each of the generated elements of output data may also include a numerical score (e.g., ranging from zero to unity) indicative of a predicted likelihood that the corresponding one of the customers will experience, or will be involved in, each of the plurality of targeted redemption events (e.g., an occurrence of a full redemption event, an occurrence of a partial redemption event, or a non-occurrence of a redemption event) within a future temporal interval, such as, but not limited to, a two-month interval disposed between one and three months from the date specified by the temporal identifier within the respective one of the validation datasets.

Further, and as described herein, the distributed components of FI computing system 130 may perform any of the exemplary processes described herein in parallel to validate the adaptively trained, gradient-boosted, decision-tree process described herein based on the application of the adaptively trained, gradient-boosted, decision-tree process (e.g., configured in accordance with the candidate process parameters) to each of the validation datasets. The parallel implementation of these exemplary adaptive validation processes by the distributed components of FI computing system 130 may, in some instances, be based on an implementation, across the distributed components, of one or more of the parallelized, fault-tolerant distributed computing and analytical protocols described herein.

In some examples, FI computing system 130 may perform any of the exemplary processes described herein to compute a value of one or more metrics that characterize a predictive capability, and an accuracy, of the adaptively trained machine-learning or artificial intelligence process (such as the adaptively trained, gradient-boosted, decision-tree process described herein) based on the generated elements of output data and corresponding ones of the validation datasets (e.g., in step 322 of FIG. 3), and to determine whether all, or a selected portion of, the computed metric values satisfy one or more threshold conditions for a deployment of the adaptively trained machine-learning or artificial intelligence process (e.g., in step 324 of FIG. 3). As described herein, and for the adaptively trained, gradient-boosted, decision-tree process, the computed metrics may include, but are not limited to, one or more recall-based values (e.g., “recall@5,” “recall@10,” “recall@20,” etc.), one or more precision-based values for the adaptively trained, gradient-boosted, decision-tree process, and additionally, or alternatively, a computed value of an area under curve (AUC) for a precision-recall (PR) curve, a computed value of an AUC for a receiver operating characteristic (ROC) curve associated with the adaptively trained, gradient-boosted, decision-tree process, and/or a computed values of multiclass, one-versus-all areas under curve (MAUC) for the ROC curves.

Further, and as described herein, the threshold requirements for the adaptively trained, gradient-boosted, decision-tree process may specify one or more predetermined threshold values, such as, but not limited to, a predetermined threshold value for the computed recall-based values, a predetermined threshold value for the computed precision-based values, and/or a predetermined threshold value for the computed AUC values. In some examples, FI computing system 130 may perform any of the exemplary processes described herein to establish whether one, or more, of the computed recall-based values, the computed precision-based values, or the computed AUC values exceed, or fall below, a corresponding one of the predetermined threshold values and as such, whether the adaptively trained, gradient-boosted, decision-tree process satisfies the one or more threshold requirements for deployment.

If, for example, FI computing system 130 were to establish that one, or more, of the computed metric values fail to satisfy at least one of the threshold requirements (e.g., step 324; NO), FI computing system 130 may establish that the adaptively trained machine-learning or artificial-intelligence process (e.g., the adaptively trained, gradient-boosted, decision-tree process) is insufficiently accurate for deployment and a real-time application to the elements of profile, account, transaction, portfolio, redemption, engagement, and market data described herein. Exemplary process 300 may, for example, pass back to step 310, and FI computing system 130 may perform any of the exemplary processes described herein to generate additional training datasets based on the elements of the consolidated data records maintained within the first subset.

Alternatively, if FI computing system 130 were to establish that each computed metric value satisfies threshold requirements (e.g., step 324; YES), FI computing system 130 may deem the machine-learning or artificial intelligence process (e.g., the gradient-boosted, decision-tree process described herein) adaptively trained and ready for deployment and real-time application to the elements of customer profile, account, transaction, or redemption data described herein, and may perform any of the exemplary processes described herein to generate trained process data that includes the candidate process parameters and candidate input data associated with the of the adaptively trained machine-learning or artificial intelligence process (e.g., in step 326 of FIG. 3). Exemplary process 300 is then complete in step 328.

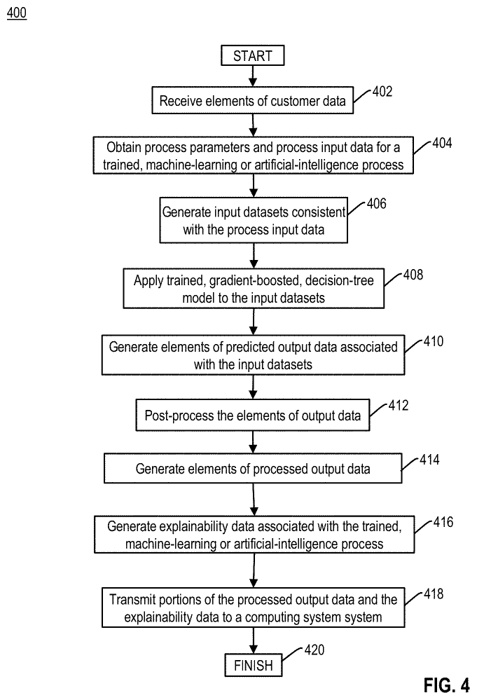

FIG. 4 is a flowchart of an exemplary process 400 for predicting likelihoods of future occurrences of targeted redemption events involving customers of a financial institution based on an application of an adaptively trained machine-learning or artificial-intelligence process to customer-specific input datasets, in accordance with the disclosed exemplary embodiments. By way of example, the elements of targeting data may identify and characterize: (i) a first targeted redemption event associated with a redemption of greater than 95% of a current market value of the shares of a mutual fund product held by a customer (e.g., a “full redemption event”), (ii) a second targeted redemption event associated with a redemption of between 10% and 95% of a current market value of the shares of a mutual fund product held by a customer (e.g., a “partial redemption event”), or (iii) a third targeted redemption event associated with a redemption of less than 10% a current market value of the shares of a mutual fund product held by a customer (e.g., a “no-redemption event”).

Further, the machine-learning or artificial-intelligence process may include an ensemble or decision-tree process, such as a gradient-boosted decision-tree process (e.g., the XGBoost process), which may be trained adaptively to predict, for a customer of the financial institution holding shares in a mutual fund product, a likelihood of an occurrence of each of the targeted redemption events during a future temporal interval using training datasets associated with a first prior temporal interval (e.g., the training interval Δt_{training}, as described herein), and using validation datasets associated with a second, and distinct, prior temporal interval (e.g., the validation interval Δt_{validation}, as described herein). In some instances, one or more computing systems, such as, but not limited to, one or more of the distributed components of FI computing system 130, may perform one or more of the steps of exemplary process 300, as described herein.

Referring to FIG. 4, FI computing system 130 may perform any of the exemplary processes described herein to receive elements of customer data that identify one or more customers of the financial institution (e.g., in step 402 of FIG. 4). For example, FI computing system 130 may receive the elements of customer data from one or more additional computing systems associated with, or operated by, the financial institution (such as, but not limited to, a product system 203), and in some instances, FI computing system 130 may perform any of the exemplary processes described herein to store the obtained elements of customer data within a locally accessible data repository (e.g., within aggregated data store 132). Further, in some instances, FI computing system 130 may also perform any of the exemplary processes described herein to synchronize and merge the obtained elements of customer data with one or more previously ingested elements of customer data maintained within the locally accessible data repository. As described herein, each of the elements of customer data may be associated with a corresponding one of the customers, and may include a customer identifier associated with the corresponding one of the customers (e.g., the alphanumeric character string, etc.) and a system identifier associated with a corresponding one of the additional computing systems (e.g., an IP or MAC address of product system 203, etc.).

FI computing system 130 may perform any of the exemplary processes described herein to generate an input dataset associated with each of the customers identified by the discrete elements of customer data 202, and to apply the adaptively trained, gradient-boosted, decision-tree process described herein to each of the input datasets, in accordance with a predetermined temporal schedule (e.g., on a daily basis, etc.), or in response to a detection of a triggering event. By way of example, and without limitation, the triggering event may correspond to a detected change in a composition of the elements of customer data 202 maintained within aggregated data store (e.g., to an ingestion of additional elements of customer data 202, etc.) or to a receipt of an explicit request received from product system 203.

For example, FI computing system 130 may also perform any of the exemplary processes described herein to obtain one or more process parameters that characterize the adaptively trained machine-learning or artificial-intelligence process (e.g., the adaptively trained, gradient-boosted, decision-tree process described herein) and elements of process input data that specify a composition of an input dataset for the adaptively trained machine-learning or artificial-intelligence process (e.g., in step 404 of FIG. 4). In some instances, and for the adaptively trained, gradient-boosted, decision-tree process described herein, the one or more process parameters may include, but are not limited to, a learning rate associated with the adaptively trained, gradient-boosted, decision-tree process, a number of discrete decision trees included within the adaptively trained, gradient-boosted, decision-tree process (e.g., the “n_estimator” for the adaptively trained, gradient-boosted, decision-tree process), a tree depth characterizing a depth of each of the discrete decision trees included within the adaptively trained, gradient-boosted, decision-tree process, a minimum number of observations in terminal nodes of the decision trees, and/or values of one or more hyperparameters that reduce potential process overfitting (e.g., regularization of pseudo-regularization hyperparameters). Further, the elements of process input data may specify the composition of the input dataset for the adaptively trained, gradient-boosted, decision-tree process, which not only identifies the elements of customer-specific data included within each input dataset (e.g., input feature values, as described herein), but also a specified sequence or position of these input feature values within the input dataset.

In some instances, FI computing system 130 may access the elements of customer data associated with one or more customers of the financial institution, and may perform any of the exemplary processes described herein to generate, for the one or more customers, an input dataset having a composition consistent with the elements of process input data (e.g., in step 406 of FIG. 4). By way of example, and as described herein, the elements of customer data may include customer identifiers associated with each of the customers of the financial institution, or with a selected subset of these customers (e.g., those customers that hold a position exceeding a predetermined value in one or more mutual funds by the financial institution), and FI computing system 130 may generate the input datasets for each of these customers in accordance with a predetermined schedule (e.g., on a daily basis) or based on a detected occurrence of a triggering event. In other examples, one or more of the elements of customer data may be associated with a customer-specific request received at the product system 203 from a device operable by a corresponding one of the customers, and FI computing system 130 may perform operations that generate the input dataset for that corresponding customer in real-time and contemporaneously with the receipt of the one or more elements of the customer data from product system 203.

Further, and based on the one or more obtained process parameters, FI computing system 130 may perform any of the exemplary processes described herein to apply the adaptively trained machine-learning or artificial-intelligence process (e.g., the adaptively trained, gradient-boosted, decision-tree process described herein) to each of the generated, customer-specific input datasets (e.g., in step 408 of FIG. 4), and to generate a customer-specific element of predicted output data associated with each of the customer-specific input datasets (e.g., in step 410 of FIG. 4). For example, and based on the one or more obtained process parameters, FI computing system 130 may perform operations, described herein, that establish a plurality of nodes and a plurality of decision trees for the adaptively trained, gradient-boosted, decision-tree process, each of which receive, as inputs (e.g., “ingest”), corresponding elements of the customer-specific input datasets. Based on the ingestion of the input datasets by the established nodes and decision trees of the adaptively trained, gradient-boosted, decision-tree process, FI computing system 130 may perform operations that apply the adaptively trained, gradient-boosted, decision-tree process to each of the customer-specific input datasets and that generate the customer-specific elements of the output data associated with the customer-specific input datasets.

As described herein, each of the customer-specific elements of the output data may include a numerical value indicative of a predicted likelihood of an occurrence of each of the targeted redemption events (e.g. an occurrence of a full redemption event, an occurrence of a partial redemption event, or a non-occurrence of a redemption event)involving, or associated with, a corresponding one of the customers during the future temporal. In some instances, each of the numerical values may range from zero (e.g., indicative of a minimal predicted likelihood) to unity (e.g., indicative of a maximum predicted likelihood), and the numerical values characterizing the predicted likelihoods of the occurrences of the first, second, and third targeted redemption events involving the corresponding one of the customers during the target interval Δt_{target} may sum to unity. Further, and as described herein, the future temporal interval may include, but is not limited to, a two-month period, and the numerical scores for each of the customers may be indicative of the predicted likelihood that the customer will be involved in corresponding ones of the targeted redemption events between one and three months subsequent to a corresponding prediction date (e.g., the prediction date t_{pred} described herein).

FI computing system 130 may also perform any of the exemplary processes described herein to post-process the customer-specific elements of output data and, among other things, associate each of the customer-specific elements of output data with a corresponding one of the customer identifiers, and in some instances, with a corresponding one of the system identifiers maintained within the elements of customer data (e.g., in step 412 of FIG. 4). Further, in some instances. FI computing system 130 may also perform operations, described herein, to package each of the customer-specific elements of output data, the associated customer identifier and system identifier, and in some instances, the process input data and a customer-specific one of the input datasets, into portions of a corresponding element of processed output data (e.g., in step 414 of FIG. 4).

Further, FI computing system 130 may also one or more elements of explainability data that characterize a relative contribution of each of the discrete features values of the input datasets (e.g., as specified within the process input data) to the predicted likelihood of the occurrences of the first, second, and third targeted redemption events during the future temporal interval (e.g., in step 416 of FIG. 4). As described herein, the relative contribution and importance of each of the discrete features to the predicted likelihoods of the occurrences of respective ones of the first, second, and third targeted redemption events may be computed based on a determined number of branching points that utilize the corresponding feature, based on a computed Shapley feature value for the corresponding feature, or based on any additional or alternate, metric indicative of the contribution of the corresponding feature to the predicted likelihoods of the occurrences of respective ones of the first, second, and third targeted redemption events.

FI computing system 130 may perform any of the exemplary processes described herein to transmit all, or a selected portion of, the elements of processed output data and the explainability data to a corresponding one of the additional computing systems associated with the financial institution, which include, but are not limited to, the product system 203 (e.g., in step 418 of FIG. 4). Exemplary process 400 is then complete in step 420.

### C. Exemplary Computer-Implemented Processes for Determining Redemption Personas Based on Explainability Data

Further, in some examples, product system 203 may also perform operations that analyze the customer-specific elements of processed output data 236 (e.g., that link together customer-specific elements of customer data, output data elements, and in some instances input datasets), either individually of in conjunction with explainability data 184, to identify and characterize one or more patterns that, if detected within the elements of profile, account, transaction, portfolio, redemption, engagement, and market data characterizing a corresponding customer of the financial institution that holds a shares of a mutual fund product, indicate a likelihood of an initiation, by the corresponding customer, of a full or partial redemption event involving the mutual fund. The one or more identified patterns may include patterns in the spending or savings behavior of the corresponding customer over one or more temporal intervals and/or patterns characterizing interactions of the corresponding customer with the mutual fund product, with other investment products, or with one or more savings products or payment instrumented provisioned by the financial institution over the one or more temporal intervals. In some instances, described herein, the one or more identified patterns may establish corresponding redemption personals for the customers of the financial institution, and when coupled with additional data characterizing one or more strategies to mitigate, or reduce, the likelihood of the future redemption events associated with the identified patterns, the redemption personals may enable the financial institution to engage in personalized, proactive interaction with customers to further reduce the likelihood of future redemption events.

As described herein, processed output data 236 may include elements of customer data 202 that identify and characterize corresponding customers of the financial institution that hold a position in one or more mutual funds valued in excess of a predetermined value (e.g., $1,500, etc.). Processed output data 236 may also include elements of output data 230 that include the numerical values P₁, P₂, and P₃ indicative of the predicted likelihood of an occurrence of each of the first targeted redemption event (e.g., the full redemption event), the second targeted redemption event (e.g., the partial redemption event), and the third targeted redemption event (e.g., the non-occurrence of any redemption event) involving the corresponding customers during the future temporal interval, and in some instances, input datasets 224 associated with the corresponding customers. By way of example, and for a particular customer of the financial institution, processed output data 236 may maintain element 238 that associates element 206 of customer data 202 (which includes customer identifier 208 of the particular customer) and element 234 of output data 230 that includes a linear array {0.19, 0.75, and 0.06}, which indicates a 19% probability that the particular customer will initiate a full redemption event involving shares valued at greater than 95% of a current market value of the mutual fund product (e.g., the first targeted redemption event, described herein), a 75% probability the particular customer will initiate a partial redemption event involving shares valued at between with 10% and 95% of the current market value of the mutual fund product (e.g., the second targeted redemption event, described herein), and a 6% probability that the particular customer will initiate a redemption event involving shares valued below 10% of the current market value of the mutual fund product (e.g., the third targeted redemption event, described herein). Further, element 238 may also include process input data 182, which characterizes a composition of an input dataset for the adaptively trained, gradient-boosted, decision-tree process and identifies each of the discrete data elements within the input dataset.

Further, the elements of explainability data 184 may characterize a relative contribution of each of the discrete features to the predicted likelihood of the occurrence of the first targeted redemption event during the target interval Δt_{target} (e.g., first subset 186 of explainability data 184); the predicted likelihood of the occurrence of the second targeted redemption event during the target interval Δt_{target} (e.g., second subset 188 of explainability data 184); and the predicted likelihood of the occurrence of the third targeted redemption event during the target interval Δt_{target} (e.g., third subset 190 of explainability data 184). In some instances, the relative contribution and importance of each of the discrete features to the predicted likelihoods of the occurrences of respective ones of the first, second, and third targeted redemption events may be determined (e.g., by executed adaptive training and validation module 172 of FIG. 1B) based on a determined number of branching points that utilize the corresponding feature, based on a computed Shapley feature value for the corresponding feature, or based on any additional or alternate, metric indicative of the contribution of the corresponding feature to the predicted likelihoods of the occurrences of respective ones of the first, second, and third targeted redemption events.

In some examples (not illustrated in FIG. 2), product system 203 may perform operations that parse process input data 182 and obtain identifiers of each of the unique features included within the input dataset for the adaptively trained, gradient-boosted, decision-tree process. Further, product system 203 may also perform operations that parse each of subsets 186, 188, and 190 of explainability data, and obtain feature contribution values that characterize a contribution of each of the unique features to the respective ones of the predicted likelihood of the occurrence of the first targeted redemption event involving customers of the financial institution during the target interval Δt_{target} (e.g., first subset 186) and the predicted likelihood of the occurrence of the second targeted redemption event involving the customers during the target interval Δt_{target} (e.g., second subset 188). As described herein, and for each of the customers characterized by the customer-specific elements of processed output data 236, the feature contribution values may characterize an importance of corresponding ones of the features to the predicted likelihood of full, partial, or no redemption for a corresponding customer, and a feature contribution value may indicate an importance of a feature in making a prediction about the corresponding customer, and a direction in which the feature changed the prediction output data for the corresponding customer.

In some instances, the feature identifiers of each of the unique feature and corresponding ones of the feature contributions may establish variable pairs for associated with the predicted occurrences of each of the first targeted redemption event (e.g., the full redemption event) and the second targeted redemption event (e.g., the partial redemption event), and product system 203 may perform operations that apply one or more statistical processes, such as a factor-analysis process, to the variable pairs for associated with the predicted occurrences of the first targeted redemption event (e.g., the full redemption event) and additionally, or alternatively, to the variable pairs for associated with the predicted occurrences of the second targeted redemption event (e.g., the partial redemption event). Based on the application of the factor-analysis process to the variable pairs for associated with the predicted occurrences of the first targeted redemption event and/or the second targeted redemption event, product system 203 may determine that a subset of the variable pairs segment the customers associated with the predicted occurrences of the first targeted redemption event and/or the second targeted redemption event.

In some examples, product system 203 may parse the elements of processed output data 236, and obtain a subset of those elements that indicate a likely occurrence of a full or a partial redemption event involving the corresponding customers during the future temporal interval (e.g., element 238 of processed output data 236, which element 234 of output data 230 indicating a 75% probability that the customer associated with customer identifier 208 will initiate a partial redemption during the future temporal interval). Product system 203 may also perform operations that obtain customer-specific feature values associated with the subset of the variable pairs and those customers associated with the likely occurrence of the full or partial redemption event (e.g., as specified within corresponding ones of input datasets 224, such as input dataset 226 associated with customer identifier 208)). In some instances, product system 203 may apply an additional, trained machine-learning or artificial-intelligence process, such as a trained k-means process, to all, or a selected portion, of the variable pairs, the obtained customer-specific feature values, and the obtained elements of processed output data 236. Further, and based on the trained k-means process, to the portions of the variable pairs, the obtained customer-specific feature values, and the obtained elements of processed output data 236, product system 203 may generate elements of clustering data that identify, and characterize, corresponding clusters of the customers that exhibit distinct, and common, cluster-specific behaviors related to the full or partial redemption of the mutual fund products.

The identified clusters may, for examples, establish corresponding distinct, or overlapping redemption personas, and the redemption personas may inform an approach taken by product system 203, or by one or more representatives of the financial institution, to proactively engage the customers in an attempt to prevent the predicted future redemption events. By way of example, and for a corresponding one of the identified clusters of customer, the clustering data may include, among other things, a cluster size and percentage of customers falling into the persona, a redemption behavior ranging from controllable to uncontrollable for the customers falling into the persona, a probability of redemption, a description of common, cluster-specific behaviors related to the full or partial redemption of the mutual fund products by these customers. Examples of these cluster-specific behaviors include, but are not limited to, maintaining a high or low balance associated with one or more secured or unsecured credit products, holding a large or small portion of a customer's total investment portfolio in mutual fund products, a level of entrenchment with the financial institution, or holding mutual fund products or other investment products with low, or low, rates of returns.

Further, in some examples, and based on a review of the cluster-specific behaviors, product system 203 may generate additional data that identifies and characterizes one or more suggested approaches to reduce a likelihood of full or partial redemption by these customers. Examples of these suggested approaches may include, among other things, increased outreach regarding a performance of one or more mutual fund products, budgetary counseling, or education on market volatility or benefits associated with long-term investment. In some instances, for each of the clusters of the corresponding customers, product system 203 may package the elements of the clustering data and the additional data into corresponding elements of persona data, which product system 203 may maintained within a tangible, non-transitory memory. Through a deployment these redemption personas, the financial institution to engage in personalized, proactive interaction with customers to further reduce the likelihood of future redemption events.

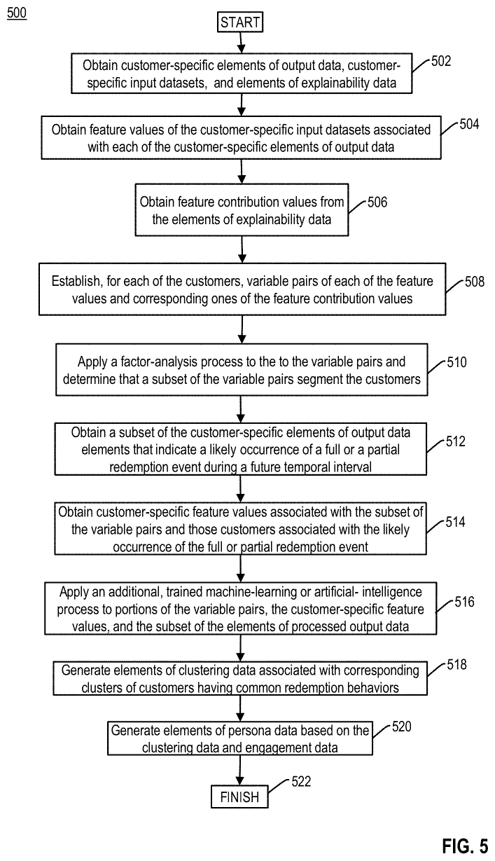

FIG. 5 is a flowchart of an exemplary process 500 for generating redemption personas based on dynamically generated explainability data characterizing trained, machine-learning or artificial-intelligence processes. In some instances, one or more computing systems associated with the financial institution, such as, but not limited to, product system 203, may perform one or of the steps of exemplary process 500, as described herein. Referring to FIG. 5, product system 203 may perform any of the exemplary processes described herein to obtain one or more customer-specific elements of output data generated through an application of a trained machine-learning or artificial-intelligence process (e.g., a gradient-boosted, decision-tree process, such as an XGBoost process) to a customer-specific input dataset composed of values of corresponding input features, and elements of explainability data may characterize a relative contribution of each of the input features to the generated output data (e.g., in step 502 of FIG. 5). Further, in some instances, product system 203 may perform any of the exemplary processes described herein to obtain each of the customer-specific input datasets, along with elements of process input data that identify each of the input features and position of the corresponding input feature value within each of the customer-specific input datasets (e.g., also in step 502 of FIG. 5).

As described herein, each element of output data may be associated with a corresponding one of the customers (e.g., that hold a position in one or more mutual funds valued in excess of a predetermined value, such as the $1,500 limit described herein) and may include, among other things, a unique customer identifier and customer-specific numerical values P₁, P₂, and P₃ that indicative of the predicted likelihood of an occurrence of each of the first targeted redemption event (e.g., the full redemption event), the second targeted redemption event (e.g., the partial redemption event), and the third targeted redemption event (e.g., the non-occurrence of any redemption event) involving the corresponding customer during the future temporal interval. Further, and as described herein, the elements of explainability data may characterize a relative contribution of each of the discrete input features to the predicted likelihood of the occurrence of the first targeted redemption event during the target interval Δt_{target}, the predicted likelihood of the occurrence of the second targeted redemption event during the target interval Δt_{target}, and the predicted likelihood of the occurrence of the third targeted redemption event during the target interval Δt_{target}. In some instances, the relative contribution and importance of each of the discrete features to the predicted likelihoods of the occurrences of respective ones of the first, second, and third targeted redemption events may be determined based on a determined number of branching points that utilize the corresponding feature, based on a computed Shapley feature value for the corresponding feature, or based on any additional or alternate, metric indicative of the contribution of the corresponding feature to the predicted likelihoods of the occurrences of respective ones of the first, second, and third targeted redemption events.

Referring back to FIG. 5, product system 203 may perform operations that parse the each of the customer-specific input datasets and obtain feature values for each unique features included within the input dataset for the adaptively trained, machine-learning or artificial-intelligence process (e.g., in step 504 of FIG. 5), and that parse the elements of explainability data, and obtain feature contribution values that characterize a contribution of each of the unique features to the respective ones of the predicted likelihood of the occurrence of the first targeted redemption event involving customers of the financial institution during the target interval Δt_{target} and the predicted likelihood of the occurrence of the second targeted redemption event involving the customers during the target interval Δt_{target} (e.g., in step 506 of FIG. 5). As described herein, and for each of the customers characterized by the customer-specific elements of output data, the feature contribution values may characterize an importance of corresponding ones of the features to the predicted likelihood of full, partial, or no redemption for a corresponding customer, and a feature contribution value may indicate an importance of a feature in making a prediction about the corresponding customer, and a direction in which the feature changed the prediction output data for the corresponding customer.

In some instances, in step 508 of FIG. 5, product system 203 may perform operations, described herein, that establish, for each of the customers, variable pairs of each of the feature values and corresponding ones of the feature contribution values associated with the predicted occurrences of the first targeted redemption event (e.g., the full redemption event) and the second targeted redemption event (e.g., the partial redemption event). Product system 203 may perform any of the exemplary processes described herein to that apply one or more statistical processes, such as a factor-analysis process, to the variable pairs for associated with the predicted occurrences of the first targeted redemption event (e.g., the full redemption event) and additionally, or alternatively, to the variable pairs for associated with the predicted occurrences of the second targeted redemption event (e.g., the partial redemption event), and based on the application of the factor-analysis process to the variable pairs for associated with the predicted occurrences of the first targeted redemption event and/or the second targeted redemption event, determine that a subset of the variable pairs segment the customers associated with the predicted occurrences of the first targeted redemption event and/or the second targeted redemption event (e.g., in step 510 of FIG. 5).

Product system 203 may also parse the customer-specific elements of output data, and obtain a subset of those elements that indicate a likely occurrence of a full or a partial redemption event involving the corresponding customers during the future temporal interval (e.g., in step 512 of FIG. 5). Product system 203 may also perform operations that obtain customer-specific feature values associated with the subset of the variable pairs and those customers associated with the likely occurrence of the full or partial redemption event from corresponding ones of customer-specific input datasets (e.g., also in step 514 of FIG. 5). In some instances, product system 203 may perform operations, described herein, to apply an additional, trained machine-learning or artificial-intelligence process, such as a trained k-means process, to all, or a selected portion, of the variable pairs, the obtained customer-specific feature values, and the obtained elements of processed output data (e.g., in step 516 of FIG. 5). Further, and based on the trained k-means process, to the portions of the variable pairs, the obtained customer-specific feature values, and the obtained elements of processed output data 236, product system 203 may generate elements of clustering data that identify, and characterize, corresponding clusters of the customers that exhibit distinct, and common, cluster-specific behaviors related to the full or partial redemption of the mutual fund products (e.g., in step 518 of FIG. 5).

The identified clusters may, for example, establish corresponding distinct, or overlapping redemption personas, and the redemption personas may inform an approach taken by product system 203, or by one or more representatives of the financial institution, to proactively engage the customers in an attempt to prevent the predicted future redemption events. By way of example, and for a corresponding one of the identified clusters of customer, the clustering data may include, among other things, a cluster size and percentage of customers falling into the persona, a redemption behavior ranging from controllable to uncontrollable for the customers falling into the persona, a probability of redemption, a description of common, cluster-specific behaviors related to the full or partial redemption of the mutual fund products by these customers. Examples of these cluster-specific behaviors include, but are not limited to, maintaining a high or low balance associated with one or more secured or unsecured credit products, holding a large or small portion of a customer's total investment portfolio in mutual fund products, a level of entrenchment with the financial institution, or holding mutual fund products or other investment products with low, or low, rates of returns.

Further, in some examples, and based on a review of the cluster-specific behaviors, product system 203 may generate engagement data that identifies and characterizes one or more suggested approaches to reduce a likelihood of full or partial redemption by these customers, and package the elements of the clustering data and the engagement data into corresponding elements of persona data for corresponding ones of the customers (e.g., in step 520 of FIG. 5). Examples of these suggested approaches may include, among other things, increased outreach regarding a performance of one or more mutual fund products, budgetary counseling, or education on market volatility or benefits associated with long-term investment, and through a deployment these redemption personas, the financial institution to engage in personalized, proactive interaction with customers to further reduce the likelihood of future redemption events. Exemplary process 500 is then complete in step 522.

### D. Exemplary Hardware and Software Implementations

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Exemplary embodiments of the subject matter described in this specification, including, but not limited to, application programming interfaces (APIs) 134 and 204, data ingestion engine 136, pre-processing engine 140, training engine 162, training input module 166, adaptive training and validation module 172, model input engine 212, predictive engine 228, and post-processing engine 232, can be implemented as one or more computer programs, i.e., one or more modules of computer program instructions encoded on a tangible non transitory program carrier for execution by, or to control the operation of, a data processing apparatus (or a computer system).

Additionally, or alternatively, the program instructions can be encoded on an artificially generated propagated signal, such as a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The terms “apparatus,” “device,” and “system” refer to data processing hardware and encompass all kinds of apparatus, devices, and machines for processing data, including, by way of example, a programmable processor such as a graphical processing unit (GPU) or central processing unit (CPU), a computer, or multiple processors or computers. The apparatus, device, or system can also be or further include special purpose logic circuitry, such as an FPGA (field programmable gate array) or an ASIC (application-specific integrated circuit). The apparatus, device, or system can optionally include, in addition to hardware, code that creates an execution environment for computer programs, such as code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, such as one or more scripts stored in a markup language document, in a single file dedicated to the program in question, or in multiple coordinated files, such as files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, such as an FPGA (field programmable gate array), an ASIC (application-specific integrated circuit), one or more processors, or any other suitable logic.

Computers suitable for the execution of a computer program include, by way of example, general or special purpose microprocessors or both, or any other kind of central processing unit. Generally, a CPU will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, such as magnetic, magneto-optical disks, or optical disks. However, a computer need not have such devices. Moreover, a computer can be embedded in another device, such as a mobile telephone, a personal digital assistant (PDA), a mobile audio or video player, a game console, a Global Positioning System (GPS) receiver, or a portable storage device, such as a universal serial bus (USB) flash drive, to name just a few.

Computer-readable media suitable for storing computer program instructions and data include all forms of non-volatile memory, media and memory devices, including by way of example semiconductor memory devices, such as EPROM, EEPROM, and flash memory devices; magnetic disks, such as internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display unit, such as a CRT (cathode ray tube) or LCD (liquid crystal display) monitor, for displaying information to the user and a keyboard and a pointing device, such as a mouse or a trackball, by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, such as a data server, or that includes a middleware component, such as an application server, or that includes a front-end component, such as a computer having a graphical user interface or a web browser through which a user can interact with an implementation of the subject matter described in this specification, or any combination of one or more such back-end, middleware, or front-end components. The components of the system can be interconnected by any form or medium of digital data communication, such as a communication network. Examples of communication networks include a local area network (LAN) and a wide area network (WAN), such as the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, such as an HTML page, to a user device, such as for purposes of displaying data to and receiving user input from a user interacting with the user device, which acts as a client. Data generated at the user device, such as a result of the user interaction, can be received from the user device at the server.

While this specification includes many specifics, these should not be construed as limitations on the scope of the invention or of what may be claimed, but rather as descriptions of features specific to particular embodiments of the invention. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

Various embodiments have been described herein with reference to the accompanying drawings. It will, however, be evident that various modifications and changes may be made thereto, and additional embodiments may be implemented, without departing from the broader scope of the disclosed embodiments as set forth in the claims that follow.

Further, other embodiments will be apparent to those skilled in the art from consideration of the specification and practice of one or more embodiments of the present disclosure. It is intended, therefore, that this disclosure and the examples herein be considered as exemplary only, with a true scope and spirit of the disclosed embodiments being indicated by the following listing of exemplary claims.

What is claimed is:

1. An apparatus, comprising:
a memory storing instructions;
a communications interface; and
at least one processor coupled to the memory and the communications interface, the at least one processor being configured to execute the instructions to:
generate an input dataset based on elements of first interaction data associated with a first temporal interval;
based on an application of a trained artificial intelligence process to the input dataset, generate output data representative of a predicted likelihood of an occurrence of each of a plurality of targeted events during a second temporal interval, the second temporal interval being subsequent to the first temporal interval and being separated from the first temporal interval by a corresponding buffer interval; and
transmit at least a portion of the output data and explainability data associated with the trained artificial intelligence process to a computing system via the communications interface, the computing system being configured to perform operations based on the portion of the output data and the explainability data.

2. The apparatus of claim 1, wherein the at least one processor is further configured to:
receive at least a portion of the interaction data from the computing system via the communications interface; and
store the received portion of the interaction data within the memory.

3. The apparatus of claim 1, wherein the at least one processor is further configured to:
obtain (i) one or more parameters that characterize the trained artificial intelligence process and (ii) data that characterizes a composition of the input dataset;
generate the input dataset in accordance with the data that characterizes the composition; and
apply the trained artificial intelligence process to the input dataset in accordance with the one or more parameters.

4. The apparatus of claim 3, wherein the at least one processor is further configured to:
based on the data that characterizes the composition, perform operations that at least one of extract a first feature value from the interaction data or compute a second feature value based on the first feature value; and
generate the input dataset based on at least one of the extracted first feature value or the computed second feature value.

5. The apparatus of claim 1, wherein the trained artificial intelligence process comprises a trained, gradient-boosted, decision-tree process.

6. The apparatus of claim 1, wherein the at least one processor is further configured to execute the instructions to:
obtain elements of second interaction data, each of the elements of the second interaction data comprising a temporal identifier associated with a temporal interval;
based on the temporal identifiers, determine that a first subset of the elements of the second interaction data are associated with a prior training interval, and that a second subset of the elements of the second interaction data are associated with a prior validation interval;
generate a plurality of training datasets based on corresponding portions of the first subset;
obtain elements of targeting data identifying each of the targeted events; and
perform operations that train the artificial intelligence process based on the training datasets and the targeting data.

7. The apparatus of claim 6, wherein the at least one processor is further configured to execute the instructions to:
generate a plurality of validation datasets based on portions of the second subset;
apply the trained artificial intelligence process to the plurality of validation datasets, and generate additional elements of output data based on the application of the trained artificial intelligence process to the plurality of validation datasets;
compute one or more validation metrics based on the additional elements of output data; and
based on a determined consistency between the one or more validation metrics and a threshold condition, validate the trained artificial intelligence process.

8. The apparatus of claim 1, wherein:
the plurality of targeted events comprise a first targeted redemption event, a second targeted redemption event, and a third targeted redemption event, each of the first, second, and third targeted redemption events; and
the output data comprises a first numerical score indicative of a predicted likelihood of an occurrence of the first targeted redemption event during the second temporal interval, a second numerical score indicative of a predicted likelihood of an occurrence of the second, and a third numerical score indicative of a predicted likelihood of an occurrence of the third targeted redemption event during the second temporal interval.

9. The apparatus of claim 8, wherein:
each of the first, second, and third targeted redemption events is associated with a product;
the first targeted redemption event corresponds to a full redemption of the product during the second temporal interval, the second targeted redemption event corresponds to a partial redemption of the product during the second temporal interval, and the third targeted redemption event corresponds to a non-occurrence of the full or partial redemption of the product during the second temporal interval.

10. The apparatus of claim 1, wherein:
the input dataset comprises feature values associated with a plurality of input features;
the explainability data comprises a feature contribution value characterizing a contribution of each of the input feature values to the predicted likelihood of the occurrences of the targeted events during the second temporal interval.

11. The apparatus of claim 10, wherein:
each of the targeted events are associated with a redemption of a product;
the at least one processor is further configured to execute the instructions to transmit the input dataset to the computing system;
the computing system is further configured to:
select a subset of the features values based on an application of a factor analysis process to the feature contribution values;
based on an application of a trained machine-learning or artificial-intelligence process to the subset of the feature values and to corresponding elements of the output data, generate clustering data characterizing a plurality of customer clusters, each of the customer clusters being associated with a corresponding redemption profile.

12. A computer-implemented method, comprising:
generating, using at least one processor, an input dataset based on elements of first interaction data associated with a first temporal interval;
based on an application of a trained artificial intelligence process to the input dataset, generating, using the at least one processor, output data representative of a predicted likelihood of an occurrence of each of a plurality of targeted events during a second temporal interval, the second temporal interval being subsequent to the first temporal interval and being separated from the first temporal interval by a corresponding buffer interval; and
transmitting, using the at least one processor, at least a portion of the output data and elements of explainability data associated with the trained artificial intelligence process to a computing system, the computing system being configured to perform operations based on the portion of the output data and the explainability data.

13. The computer-implemented method of claim 12, wherein:
the computer-implemented method further comprises, using the at least one processor, obtaining (i) one or more parameters that characterize the trained artificial intelligence process and (ii) data that characterizes a composition of the input dataset;
generating the input dataset comprises generating the input dataset in accordance with the data that characterizes the composition; and
the computer-implemented method further comprises applying, using the at least one processor, the trained artificial intelligence process to the input dataset in accordance with the one or more parameters.

14. The computer-implemented method of claim 13, wherein:
the computer-implemented method further comprises, based on the data that characterizes the composition, performing operations, using the at least one processor, that at least one of extract a first feature value from the interaction data or compute a second feature value based on the first feature value; and
generating the input dataset comprises generating the input dataset based on at least one of the extracted first feature value or the computed second feature value.

15. The computer-implemented method of claim 12, wherein the trained artificial intelligence process comprises a trained, gradient-boosted, decision-tree process.

16. The computer-implemented method of claim 12, further comprising:
obtaining, using the at least one processor, elements of second interaction data, each of the elements of the second interaction data comprising a temporal identifier associated with a temporal interval;
based on the temporal identifiers, determining, using the at least one processor, that a first subset of the elements of the second interaction data are associated with a prior training interval, and that a second subset of the elements of the second interaction data are associated with a prior validation interval;
generating, using the at least one processor, a plurality of training datasets based on corresponding portions of the first subset;
obtaining, using the at least one processor, elements of targeting data identifying each of the targeted events; and
performing operations, using the at least one processor, that train the artificial intelligence process based on the training datasets and the targeting data.

17. The computer-implemented method of claim 16, further comprising:
generating, using the at least one processor, a plurality of validation datasets based on portions of the second subset;
using the at least one processor, applying the trained artificial intelligence process to the plurality of validation datasets, and generate additional elements of output data based on the application of the trained artificial intelligence process to the plurality of validation datasets;
computing, using the at least one processor, one or more validation metrics based on the additional elements of output data; and
based on a determined consistency between the one or more validation metrics and a threshold condition, validating the trained artificial intelligence process using the at least one processor.

18. The computer-implemented method of claim 11, wherein:
the plurality of targeted events comprise a first targeted redemption event, a second targeted redemption event, and a third targeted redemption event, each of the first, second, and third targeted redemption events; and
the output data comprises a first numerical score indicative of a predicted likelihood of an occurrence of the first targeted redemption event during the second temporal interval, a second numerical score indicative of a predicted likelihood of an occurrence of the second, and a third numerical score indicative of a predicted likelihood of an occurrence of the third targeted redemption event during the second temporal interval.

19. The computer-implemented method of claim 11, wherein:
the input dataset comprises feature values of a plurality of input features, and each of the targeted events are associated with a redemption of a product;
the explainability data comprises a feature contribution value characterizing a contribution of each of the feature values to the predicted likelihood of the occurrences of the targeted events during a second temporal interval;
the at least one processor is further configured to execute the instructions to transmit the input dataset to the computing system; and
the computing system is further configured to:
select a subset of the feature values based on an application of a factor analysis process to the feature contribution values;
based on an application of a trained machine-learning or artificial-intelligence process to the subset of the feature values and to corresponding elements of the output data, generate clustering data characterizing a plurality of customer clusters, each of the customer clusters being associated with a corresponding redemption profile.

20. A tangible, non-transitory computer-readable medium storing instructions that, when executed by at least one processor, cause the at least one processor to perform a method, comprising:
generating an input dataset based on elements of first interaction data associated with a first temporal interval;
based on an application of a trained artificial intelligence process to the input dataset, generating output data representative of a predicted likelihood of an occurrence of each of a plurality of targeted events during a second temporal interval, the second temporal interval being subsequent to the first temporal interval and being separated from the first temporal interval by a corresponding buffer interval; and
transmitting at least a portion of the output data and elements of explainability data associated with the trained artificial intelligence process to a computing system, the computing system being configured to perform operations based on the portion of the output data and the explainability data.
